(19) United States
(12) Patent Application Publication
(10) Pub. No.: US 2011/0129796 A1
(43) Pub. Date: Jun. 2, 2011

(54) DENTURES, DENTAL ARCHES AND METHODS OF MANUFACTURE

(76) Inventor: Sebastian Riggio, Victoria (AU)

(21) Appl. No.: 12/997,570

(22) PCT Filed: Jun. 11, 2009
(86) PCT No.: PCT/AU2009/000731

§ 371 Date: Feb. 16, 2011

(30) Foreign Application Priority Data
Jun. 11, 2008 (AU) 2008902951
Dec. 22, 2008 (AU) 2008906576

(51) Int. Cl. A61C 13/01

(52) U.S. Cl. 433/171; 433/199.1

(57) ABSTRACT

Dentures, dental arches, and methods of manufacture are disclosed as well as supports for dental arches and artificial teeth. The support for a dental arch comprises an elongate member curved to substantially follow a curve of a dental arch and can comprise one or more apertures through the elongate member for the attachment of artificial teeth. Vertical and lateral positions of the artificial teeth are adjustable as well as the incisal inclination. Embodiments of the support can comprise at least one joint between at least two parts of the support. Methods and apparatus for determining dental size and shape are also disclosed as well as trays, flexible, cushioning inserts, molds and indenting members for denture manufacture.

### FIELD OF THE INVENTION

The present invention relates to dentures, dental arches and methods of manufacture. In particular, although not exclusively, the present invention relates to improved upper and lower dentures, clinical and laboratory methods, materials and apparatus for their production.

### BACKGROUND TO THE INVENTION

Replacement, artificial or false teeth are required where all teeth have been lost or have had to be removed for one reason or another, such as medication, accidental atrophy, disease or wear with old age. The most common form of full edentulous artificial teeth are in the form of removable dentures, which typically comprise a full set of upper and/or lower teeth, usually minus the wisdom teeth. The denture is sized and shaped to rest on the soft tissues of the patient's jaw referred to as the oral ridge. Hundreds of millions of dentures are in use worldwide.

Advances in materials have enabled dentures to be more durable and more natural looking and the development of denture designs has improved comfort and chewing efficiency. However, the process for making dentures, for both clinical and laboratory procedures, has changed little for decades and because dentures are tailored to each patient, they cannot be mass produced. The manufacturing process therefore remains both time consuming and labour intensive. Furthermore, the patient is inconvenienced by the delays associated with manufacturing the denture and once the denture is finished the patient may still experience discomfort from ill-fitting denture(s) caused by patient jaw relation inconsistencies, clinical and laboratory errors, including transit mishaps, all affecting the manufacturing process.

The conventional process for producing a denture typically includes multiple clinical consultations between the patient and the denture practitioner and each clinical consultation is typically followed by work being performed by a dental technician. Often the premises or laboratory of the dental technician who performs the clinical stages required to finish the dentures are remote from the denture practitioner's surgery. Therefore, impressions, casts and especially an articulation apparatus used to make the dentures, as will be described hereinafter, need to be transported back and forth between the denture practitioner's surgery and the laboratory of the dental technician. This exacerbates the delay associated with producing the denture and incurs transport costs and further labour costs, ultimately for the practitioner and therefore for the patient.

Following an initial assessment of the patient by the denture practitioner, the process of manufacturing a denture commences with primary impressions of the patient's upper and lower mouth being taken using stock trays. The primary impressions are sent to the technician who casts impressions in stone from which special trays are produced for the patient. The special trays are sent to the denture practitioner who takes secondary impressions using the special trays. The technician casts secondary impressions in stone and produces wax registration rims from the stone secondary impressions. The registration of the patient's jaw relations are taken with the aid of wax registration rims which are then temporarily attached together according to the patient's tempro-mandibular joint (TMJ) positions and centric and vertical dimensions including occlusal planes and the cuspid regions as points of reference. A face bow and more intricate articulation systems are sometimes used by practitioners with a more refined and precise attitude towards the denture construction for their patient. The wax registration rims are then returned once more to the technician.

The technician places the attached wax registration rims on an articulator and follows the markings and dimensions placed on the rims for accurate setting up of a dentition. A range of articulators are available having varying degrees of complexity, accuracy and cost. Unfortunately, the preferred articulators that provide the best results are not always used. The artificial teeth selected for the patient are to be mounted one-by-one accurately and according to the prescribed dimensions on the wax registration rims by the technician and once waxed and sculpted meticulously and cleaned, the wax base and set up dentition is returned to the denture practitioner for trying by the patient.

At this stage, the dentition may be a good fit and have the desired appearance and all the appropriate physiological dimensions. However, often the practitioner is faced with having to deal with the fit and/or the teeth being misaligned and/or the bite being incorrect, causing the aesthetic appearance and/or function to be wrong. Such problems can be caused by clinical misinterpretation of one or more of the factors necessary to determine the perfect position of the patient's jaw relationship, caused either by improper practitioner procedures and/or imprecise and/or inconsistent control by the patient and their jaw relationship positions at the previous registration appointment. Other problematic factors may be caused in the laboratory due to wrongful preparation and/or protocol, physical impacts to the dentition and/or distortion factors inflicted on one or more of the materials and apparatus used, for example, in transit, or by the temperature sensitivity of the wax supporting the dentition or damage of any other sort. If such problems exist, the dentition must be returned to the technician who must remove and reset all of the artificial teeth, meaning that all of the extensive laborious work done in relation to registration, articulation, setting of the dentition and the wax sculpturing is wasted. The re-articulated, reset and re-waxed dentition is then returned to the denture practitioner for a re-try with the patient. This process is repeated until both the denture practitioner and the patient are happy with the result. Only then can the technician progress to a finishing stage in which the finished denture is produced. It should be appreciated that each time the technician receives the impression, registration rims or dentition from the dentist, it must be washed and sterilized before work is commenced.

The finishing stage is another labour intensive and time consuming process in which the final denture is produced from either poly-methylmethacrylate (PMMA) or MMA acrylics or other acrylics, either by conventional flasking, injection moulding or UV light cured methods. In summary, a negative stone cast of the wax with the dentition is produced within the flask. A separator liquid or release agent is added to all plaster and/or stone surfaces to create a non-cohesive layer between the uncured acrylic and surrounding plaster and/or stone cast to enable the ultimately hardened acrylic to be freely removed once the process is complete in the flask method. If the flasking method is used, the soft poly-methylmethacrylate acrylic compound is added to the flask and pressed for increased compact density. The excess is removed and re-pressed before being heated to initiate the chemical reaction causing the compound to harden. The heating process can take between one to eight hours depending on the type of compound being used. Once cooled, the denture is de-flasked, cut, festooned and polished before being sent to the denture practitioner. The other options and methods, such as the injection moulding process and composite UV appliance process, may also be used.

The patient tries the denture and checks are made to ensure that the fit and the bite is correct and there are no pain spots or unwanted discrepancies, such as premature contact, fulcrum tilting or any displeasing aesthetic factors. If such problems exist and can not be remedied or corrected in the clinic, the denture must be returned to the technician to make the appropriate further adjustments by re-articulating and undertaking either minor or major corrections until the fit is adequate and both the practitioner and patient are happy with both the fit and appearance of the denture. Based on conservative estimates and when the process runs smoothly, the aforementioned conventional process for producing a denture, including clinical and laboratory time, can take in the region of at least thirteen hours in total, excluding the transport time between the premises of the denture practitioner and the technician.

Another disadvantage of imperfect protocol being employed in the conventional dentures process is that when the dentures are finished and ill-fitting, sometimes excessively so, the dentures must often be remade from start to finish, because they can be totally irreparable at the most important stage, such as the finished stage. If for some unforseen reasons the attempted minor and/or major adjustments can not be corrected in the laboratory by the technician or by the denture practitioner whilst the patient is in the chair, the appliance is rendered a complete failure. The faulty denture needs to be discarded and the aforementioned laborious process repeated to a large extent to create a new denture. Even in the absence of specific irreparable damage, on average dentures need to be replaced every five years or so due to wear, physiological atrophy of the oral ridge leading to osseo depletion or any tissue surface change thus creating discomfort.

The prior art base is replete with attempts to improve the efficiency of the denture manufacturing process, the clinical process, denture construction and/or the quality consistency of the resulting dentures. However, none of these attempts appreciably expedite and/or improve the clinical processes, laboratory construction, manufacturing process and/or address the aforementioned problems.

In this specification, the terms “comprises”, “comprising”, “includes”, “including” or similar terms are intended to mean a non-exclusive inclusion, such that a method, system or apparatus that comprises a list of elements does not include those elements solely, but may well include other elements not listed.

### OBJECT OF THE INVENTION

It is an object of the present invention to address, or at least ameliorate, one or more of the aforementioned problems associated with the known methods of producing dentures.

It is a preferred object of the present invention to reduce the time taken to produce dentures and/or improve the quality of the dentures produced and/or the method of production of dentures.

### SUMMARY OF THE INVENTION

In one form, although it need not be the only or indeed the broadest form, the invention resides in a support for a dental arch, the support comprising an elongate member curved to substantially follow a curve of the dental arch.

Preferably, the elongate member is metallic and made of, for example, titanium, stainless steel, high carbon steel or a metal alloy, although other materials, such as ceramics, carbon fibre, at least one polymer or a fibre composite may be used.

Preferably, a face of a front or anterior region of the elongate member is substantially perpendicular to faces of rear or posterior regions of the elongate member.

Preferably, the elongate member comprises a transitional region between the anterior region and each posterior region.

Suitably, the elongate member comprises a twist between the anterior region and each posterior region.

Preferably, elongate member is twisted such that a face of the elongate member is substantially parallel to surfaces of artificial teeth of the dental arch.

Preferably, the face of the anterior region of the elongate member is substantially parallel to one or more front surfaces of artificial incisor teeth of the dental arch.

Preferably, the faces of the posterior regions of the elongate member are substantially parallel to one or more biting occlusal surfaces of artificial molar teeth and/or artificial bicuspid teeth of the dental arch.

Suitably, the anterior region of the elongate member morphs into the posterior regions of the elongate member approximately at the post cuspid regions, flattening towards a more horizontal formation at the second bi-cuspid regions and comprises substantially horizontal, planar regions approximately under the first and second molar posterior regions.

Suitably, each posterior region includes a textured surface for added mechanical retention.

Suitably, the support can include one or more apertures through the elongate member.

Suitably, the support comprises at least one joint between at least two parts of the support.

Suitably, the at least one joint is provided substantially centrally in the anterior region of the support.

Suitably, the at least one joint is provided in at least one of the posterior regions of the support.

Suitably, the support comprises a joint in a left hand posterior region, a joint in a right hand posterior region and a joint in the anterior region of the support.

Suitably, the artificial teeth are in the form of clip-on artificial teeth, which clip on to the support. The clip-on artificial teeth may be in the form of a single clip-on artificial tooth or may be in the form of clip-on units comprising multiple artificial teeth. The clip-on units may be anterior units or posterior units.

Suitably, the support comprises artificial teeth fixed to the support and one or more spaces for attaching a clip-on artificial tooth or a clip-on unit comprising multiple artificial teeth.

In another form, although again not necessarily the broadest form, the invention resides in a joint between a first part and a second part of a support for a dental arch, the joint comprising:

the first part having a projection comprising a bean shaped aperture therethrough;

the second part comprising a bean shaped recess to receive the bean-shaped projection; and

a pin passing through the bean shaped aperture in the projection and through an aperture in the recess about which the first part can pivot relative to the second part in a single plane.

Preferably, the joint comprises three contact points.

In another form, although again not necessarily the broadest form, the invention resides in a dental arch comprising:

a metallic elongate member curved to substantially follow a curve of the dental arch; and

a plurality of artificial teeth affixed to the elongate member.

Suitably, the artificial teeth are either permanently or adjustably affixed to the elongate member.

Suitably, one or more of the artificial teeth are affixed to the elongate member via a fastener passing through one of the apertures in the elongate member for attachment to a respective back of the one or more artificial teeth.

Suitably, the respective back of the one or more artificial teeth comprises a recess for engaging an end of the fastener. Alternatively, the respective back of the one or more artificial teeth comprises a male projection for engagement by a female socket in an end of the fastener.

Suitably, vertical and/or lateral positions of the artificial teeth are adjustable with respect to the apertures.

Suitably, angles of incisal inclination of the artificial teeth with respect to the anterior region of the elongate member are adjustable.

Suitably, the artificial teeth are in the form of clip-on artificial teeth, which clip on to the support.

In another form, although again not necessarily the broadest form, the invention resides in an arcuate member for assessing a size of a dental arch, the arcuate member comprising:

a pair of anterior apertures in the left and right anterior region to indicate the positions of the cuspid teeth; and

at least one pair of posterior apertures in the left and right posterior region to indicate positions of the molar teeth.

Preferably, the pair of posterior apertures indicates the mesio-buckle cusps of the first molar teeth.

Alternatively, the pair of posterior apertures indicates the positions of the second molar teeth and more particularly the positions of the center fossa of the second molar teeth.

The arcuate member may comprise two pairs of posterior apertures, a first pair of posterior apertures in the left and right posterior region to indicate positions the mesio-buckle cusps of the first molar teeth and a second pair of posterior apertures in a more posterior region than the first pair of posterior apertures to indicate positions of the second molar teeth and more particularly the positions of the center fossa of the second molar teeth.

Preferably, the relative positions of the pair of anterior apertures, the first pair of posterior apertures and/or the second pair of posterior apertures correspond to the size of the dental arch.

Preferably, the arcuate member comprises one or more indicia adjacent each anterior aperture, alignment of one of the indicia with the cuspid teeth being indicative of a tapered arch form or a square arch form.

Preferably, a handle extends from the arcuate member to facilitate use.

The arcuate member can be used on a patient's mouth or on a model of the patient's mouth.

In a further form, although not necessarily the broadest form, the invention resides in a system for assessing a size of a dental arch, the system comprising a series of arcuate members, each arcuate member comprising a pair of anterior apertures in the left and right anterior region to indicate the positions of the cuspid teeth and at least one pair of posterior apertures in the left and right posterior region to indicate positions of the molar teeth wherein the relative positions of the pair of anterior apertures and the pair of posterior apertures of each arcuate member correspond to a size of the dental arch.

Suitably, the series comprises three or more arcuate members corresponding to a scheme comprising three or more dental arch sizes. One particular scheme comprises five dental arch sizes.

Suitably, a connector can be inserted into one or more of the anterior apertures and/or one or more of the posterior apertures of the arcuate member for connecting the arcuate member to a base tray.

In a yet further form, although again not necessarily the broadest form, the invention resides in a method of determining a size of a dental arch including:

placing one or more of a series of arcuate members of different sizes on the dental arch, each arcuate member comprising a pair of anterior apertures in the left and right anterior region to measure the positions of the cuspid teeth and at least one pair of posterior apertures in the left and right posterior region to measure positions of the molar teeth; and

determining the size of the dental arch based on the arcuate member that best matches the positions of the cuspid teeth and the molar teeth.

In another form, although not necessarily the broadest form, the invention resides in a base plate material for dentures comprising an acrylic composite sheet embedded with a flexible biocompatible reinforcing mesh.

Suitably, the reinforcing mesh is biocompatible flexible fibreglass.

In a further form, although again not necessarily the broadest form, the invention resides in a length of flexible acrylic composite material comprising a series of arcuate cut-outs for alignment with artificial teeth of a denture.

Suitably, the arcuate cut-outs may be aligned with cervical regions of the artificial teeth.

Suitably, the arcuate cut-outs may be aligned with composite or acrylic collars surrounding cervico-neck regions.

In a yet further form, although not necessarily the broadest form, the invention resides in a mold for a length of flexible acrylic composite material, the mold comprising a strip having a surface pattern for imprinting embossed regions on the flexible acrylic composite material.

Preferably, the strip is metallic.

In another form, although not necessarily the broadest form, the invention resides in a flexible, cushioning insert for use in taking a mold of a dental ridge, the insert having a shape approximating to the shape of a dental arch and comprising a gel in a sealed outer layer of the insert.

Suitably, the gel and/or the outer layer of the insert are transparent.

Suitably, the insert for taking a mold of a lower dental ridge has an arcuate shape approximating to the shape of a lower dental arch.

Suitably, the insert for taking a mold of a lower dental ridge has a substantially U-shaped cross section which follows a cross sectional shape of the lower dental ridge.

Suitably, the insert for taking a mold of an upper dental ridge also takes a mold of the upper palate.

Suitably, the insert for taking a mold of an upper dental ridge and upper palate has a cross sectional shape approximately corresponding to that of the upper dental ridge and the upper palate.

In a further form, although not necessarily the broadest form, the invention resides in a base tray for an upper or lower denture formed from an acrylic composite sheet embedded with a flexible biocompatible reinforcing mesh, wherein at least one portion of the flexible biocompatible reinforcing mesh is exposed.

Preferably, the at least one exposed portion of the flexible biocompatible reinforcing mesh is a vault of the base tray for an upper denture.

Suitably, the at least one exposed portion of the flexible biocompatible reinforcing mesh is a peripheral edge of the base tray.

Suitably, a base tray for a lower denture comprises flexible labial and/or lingual regions.

In another form, although not necessarily the broadest form, the invention resides in an indenting member for attachment to a posterior region of a tissue contact side of an upper base to improve retention of an upper denture on the upper palate.

Preferably, the indenting member extends the width of the soft palate, between the left and right tuberosity of the upper ridges at the vibrating line.

Suitably, the indenting member comprises two adjacent tapering regions extending from a base of the indenting member to the compressive soft tissue over the transverse palatine suture of the palate.

In a further form, although again not necessarily the broadest form, the invention resides in a method of producing a denture including:

temporarily affixing a base to an oral ridge of a patient;

temporarily affixing a dental arch onto the base with one or more light-curable dabs of composite material;

adjusting the position of the dental arch with respect to the base and the patients' dental dimensions until the desired position is achieved; and

light-curing the dabs of composite material.

Preferably, the method includes interdigitating the occlusal surfaces of an opposing lower dental arch to a related upper dental arch after the desired position and appropriate dimensions of the upper dental arch with respect to an upper base and the patients' dental dimensions are achieved.

Alternatively, the method may include achieving the desired position and appropriate dimensions of the lower dental arch with respect to a lower base and then interdigitating the occlusal surfaces of an opposing upper dental arch to the related lower dental arch.

Further forms and features of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 shows a perspective view of a support for a dental arch;

FIG. 2 shows a plan view of the support shown in FIG. 1;

FIG. 3 shows a side view of the support shown in FIG. 1;

FIG. 4 is a partial cross-sectional view of a dental arch;

FIG. 4A is a perspective view of part of the support shown in FIG. 1 comprising artificial teeth in predetermined, fixed positions;

FIG. 5 is a perspective view of a support for a dental arch according to another embodiment;

FIG. 6 is a rear view of the support shown in FIG. 5;

FIG. 7 is a perspective view of a dental arch comprising the support shown in FIG. 5;

FIG. 8 is a side view of the support shown in FIG. 5 with an artificial anterior central tooth fixed to the anterior portion of the support;

FIG. 9 is a perspective view of an artificial tooth and fastener;

FIG. 9A shows a perspective view and a partial, enlarged side elevation of an artificial tooth and fastener according to an alternative embodiment;

FIG. 10 is a perspective view of an artificial tooth affixed loosely to the support of the dental arch;

FIGS. 10A-10F shows a range of different positions and angles in which artificial teeth can be situated on the support;

FIG. 10G is a perspective view of an artificial tooth being fixed in position on the support of the dental arch with UV cured composite material or wax;

FIG. 10H is a perspective view of an artificial tooth and fastener according to alternative embodiments;

FIG. 10J is a cross-sectional view of the artificial tooth and fastener of FIG. 10H coupled together affixing the artificial tooth loosely to the support of the dental arch;

FIG. 10K is an enlarged side view of parts of the artificial tooth and fastener of FIG. 10H;

FIGS. 11A-11D are side views of a dental arch showing an artificial incisor tooth at different angles of inclination;

FIG. 12 is a perspective view of an arcuate member for assessing the size of a dental arch;

FIG. 13 is a schematic drawing showing the correspondence between relative positions of first and third pairs of apertures of arcuate members and the size of the dental arch;

FIG. 14 shows a model of a lower dentate ridge, the positions of the left and right cuspid regions and the positions of the left and right molar regions;

FIG. 15 is a general flow diagram showing a method of determining a size of a dental arch;

FIG. 16 is an exploded view of a base plate material for making dentures;

FIG. 17 is an apron with festooning contours for finishing the labial and buckle regions of a dental appliance;

FIG. 18 is a plan view of a flexible, cushioning lower insert for use in taking molds with the composite material of dental lower ridges;

FIG. 18A is a plan view of a flexible, cushioning upper insert for use in taking molds with the composite material of upper dental ridge and upper palate;

FIG. 19 is a cross sectional view of the lower insert shown in FIG. 18;

FIG. 20 is a perspective view of a tray for taking molds of lower dental ridges;

FIG. 20A is a perspective view of a tray for taking molds of upper dental ridges and the upper palate;

FIG. 20B is another perspective view showing a position of a section through the tray in FIG. 20A;

FIG. 21 is a cross sectional view of the base plate material of FIG. 16, the insert of FIG. 18 and the tray of FIG. 20 in use;

FIG. 21A is a cross sectional view of the base plate material of FIG. 16, the insert of FIG. 18A and the tray of FIG. 20A in use;

FIG. 22 is a first part of a general flow diagram showing a clinical procedure and a laboratory method of the construction and manufacturing of a denture;

FIG. 23 is a second part of the general flow diagram of FIG. 22;

FIG. 23A is a third part of the general flow diagram of FIG. 22;

FIG. 23B is a fourth part of the general flow diagram of FIG. 22;

FIG. 24 is a chart showing a range of dental arch shapes;

FIG. 25 shows examples of different teeth shapes;

FIGS. 25A-25D show different occlusal classifications and bites;

FIG. 25E shows further occlusal set up and contact classifications accommodated by the dental arches of the present invention;

FIG. 26A shows a dental arch comprising dabs of light curable composite material;

FIGS. 26B and 26C show a dental arch temporarily attached to an upper base with dabs of light curable composite material; still in its malleable consistency not yet cured.

FIGS. 27A and 27B show an upper base and a dental arch attached with dabs;

FIG. 27C shows a four unit appliance comprising upper and lower bases with interdigitated upper and lower dental arches;

FIG. 27D shows filling lingual and labial areas of a denture with composite material;

FIG. 27E shows an alternative method of festooning the denture;

FIG. 27F shows a partially festooned denture;

FIG. 28 is a perspective view an indenting member for an upper base;

FIG. 29 shows a depression in the posterior region on a model of the upper oral ridge and palate;

FIG. 30 is a sectional view of a palate showing an indent in the soft palate created by the indenting member 140 of FIG. 28;

FIG. 31 is a sectional view of the model of FIG. 29 showing the depression;

FIG. 32 is a plan view of a two-part support comprising a joint;

FIG. 33 shows plan views of a two-part support comprising a joint and a three-part support comprising two joints;

FIG. 34 is a plan view showing various configurations of a four-part support comprising three joints;

FIG. 35 is a side view of two parts of a support showing male and female profiles comprising the joint between the two parts;

FIG. 35A is a plan view of a joint between anterior and posterior parts of a support;

FIG. 36 is a plan view of a male profile having a bean-shaped aperture;

FIG. 37 is a plan view of a female profile for receiving the male profile shown in FIG. 36;

FIGS. 38-40 shown the range of movement of a joint comprising the male and female profiles shown in FIGS. 36 and 37;

FIG. 41 is a plan view of a support and posterior and anterior clip-on units comprising artificial teeth;

FIG. 42 is a plan view of a support, posterior clip-on units comprising artificial teeth and individual artificial anterior teeth;

FIG. 42A shows further examples of upper and lower anterior and posterior clip-on units comprising artificial teeth;

FIG. 43 is a sectional side view of the support and an anterior clip-on unit comprising at least one artificial tooth;

FIG. 44 is a sectional end view of the support and a posterior clip-on unit;

FIG. 44A is perspective view of support and a posterior clip-on unit according to another embodiment;

FIG. 45 is a perspective view of a lower base tray and handle;

FIG. 46 is a perspective view of an upper base tray with the handle detached;

FIG. 47 is a perspective view of an inverted lower base tray and handle being filled with two-stage silicone based composite material;

FIG. 48 is a rear perspective partially cut-away view of an upper base;

FIG. 49 is a front perspective exploded view of the upper base of FIG. 48;

FIG. 50 is a rear view of the upper base of FIG. 48;

FIG. 51 shows a rear perspective exploded view of an upper base, a peripheral composite rod and a completed upper base;

FIG. 52 is a perspective view of an arcuate member for use with upper and lower base trays;

FIG. 53 is a perspective view of a clip on connector for use with the arcuate member of FIG. 52;

FIG. 54 is a cross sectional view of the connector of FIG. 53 connected to the arcuate member of FIG. 52;

FIG. 55 is a perspective view of an upper base plate comprising a flexible reinforcing mesh vault and the connectors of FIG. 53; and

FIG. 56 is a perspective view of a lower base plate comprising a flexible reinforcing mesh skirt.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

The structure of dental arches and accessories in accordance with embodiments of the present invention will be described followed by a description of methods of manufacturing dentures using the dental arches and other aspects of the present invention.

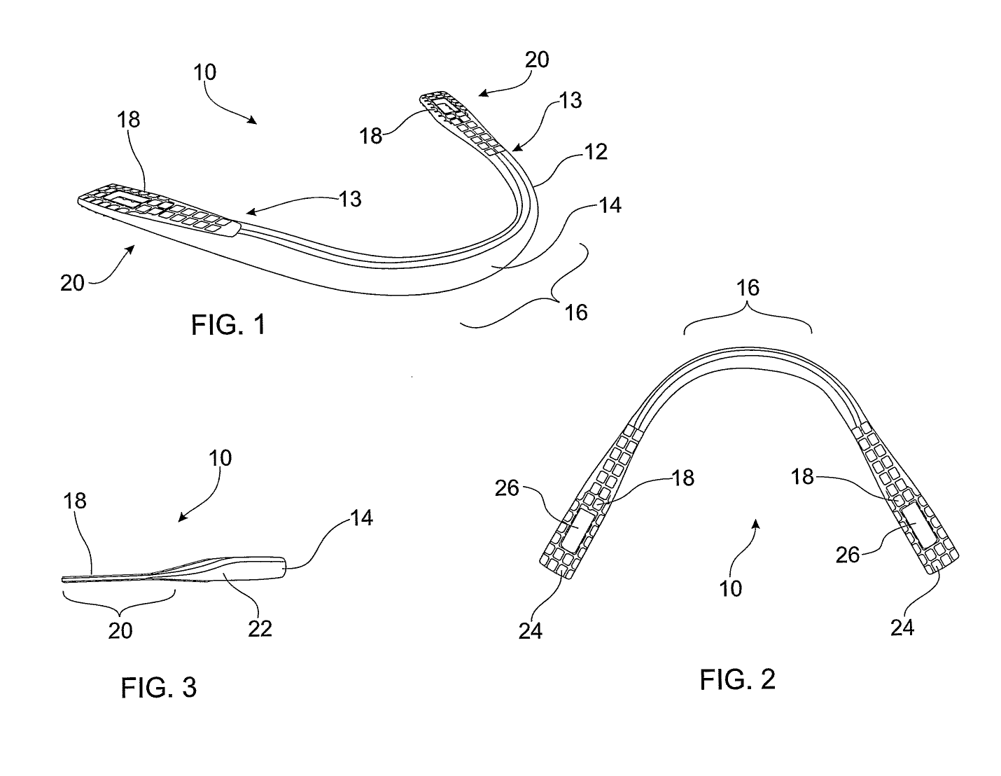

Referring to FIGS. 1-3, a support 10 for a dental arch is provided in accordance with embodiments of the present invention. The support 10 comprises a metallic elongate member 12 curved to substantially follow a curve of a dental arch. The curve can have different oral shapes, such as tapered, square, round (ovoid) or other shapes, depending on the general shape of the mouth of the patient for whom the dental arch is intended. The size of the arch will also depend on the size of the patient's mouth, the determination of which will be discussed in further detail hereinafter in accordance with another aspect of the present invention.

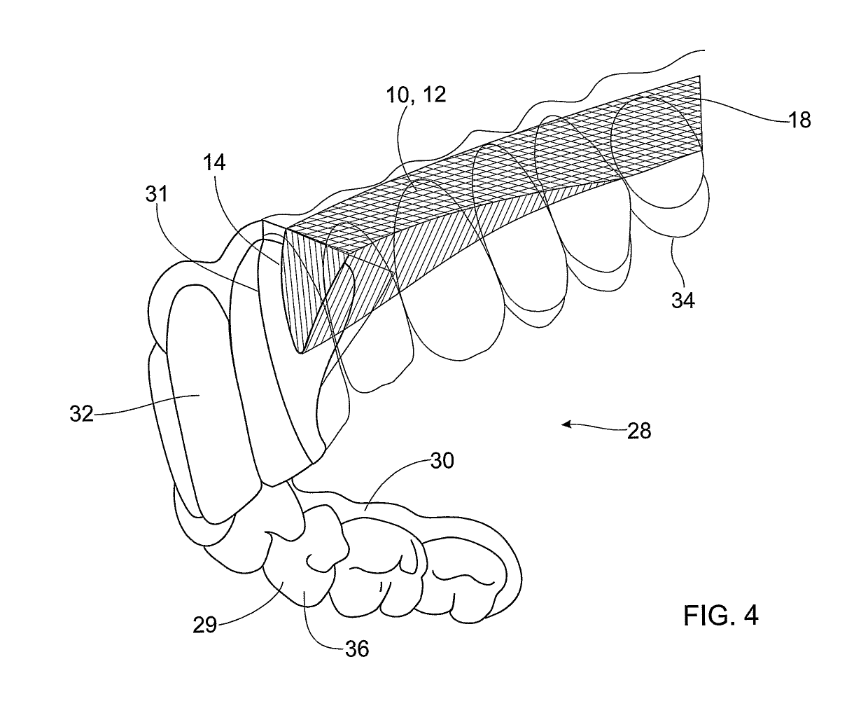

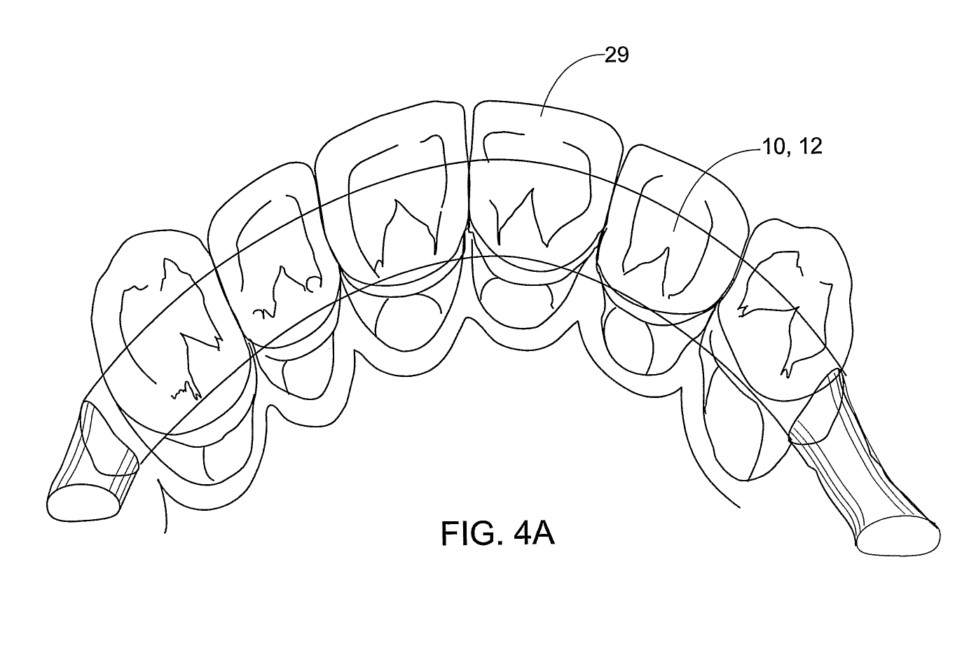

The elongate member comprises a transitional region 13 between a front or anterior region 16 and each rear or posterior region 20 such that the anterior region 16 gradually blends into or otherwise morphs into the posterior regions 20. According to some embodiments, the elongate member 12 is twisted such that a face 14 of the elongate member 12 is substantially parallel to surfaces of artificial front or anterior teeth of the dental arch. According to the embodiment shown in FIGS. 1-3, a face 14 of the anterior region 16 of the elongate member 12 is substantially perpendicular to faces 18 of the posterior regions 20 of the elongate member. The relationship between the faces of the support 12 and the surfaces of artificial teeth of the dental arch are described in further detail with reference to FIG. 4 hereinafter.

According to the embodiments shown in FIGS. 1-3, the elongate member 12 comprises a twist 22 between the anterior region 16 and each posterior region 20. The anterior region 16 of the elongate member morphs into the posterior regions 20 of the elongate member 12 approximately at the post cuspid regions, flattening towards a more horizontal formation at the second bi-cuspid regions and comprises substantially horizontal, planar regions approximately under the first and second molar posterior regions. Each posterior region 20 includes a textured surface 24 and each textured surface 24 comprises an aperture 26 through the elongate member 12. Composite material, such as ultra violet light cured (UVLC) resin, or any other available acrylic or usable material is used to bond artificial teeth to the support 10 as will be described hereinafter. The textured surfaces 24 and the apertures 26 aid in mechanical retention of the material applied to the support 10.

According to preferred embodiments, the support 10 is formed from a single length of high tensile metal to provide the required strength and rigidity to the dental arch and to the dentures made therefrom. A support made from materials such as titanium or high tensile metal cannot be easily bent, will not be distorted in normal use and is biocompatible. It is envisaged that other biocompatible metals or alloys can be used for the support 10, such as high grade stainless steel or high carbon based metals. It is also envisaged that other biocompatible materials of sufficient strength can be used for the support 10, such as ceramics, one or more polymers, fibre composites or carbon fibre materials.

With reference to FIG. 4, the dental arch 28 comprises the support 10 with a complete set of artificial teeth 29 (minus the wisdom teeth) bonded thereto with composite material 30, or other material such as a cross-linked acrylic. For the sake of clarity, FIG. 4 shows part of the support 10 with the adjacent teeth in phantom and the remainder of the dental arch 28 without the support 10 being visible. The face 14 of the front or anterior region 16 of the elongate member 12 is substantially parallel to one or more front surfaces 31 of artificial incisor teeth 32 of the dental arch 28. The faces 18 of the rear or posterior regions 20 of the elongate member 12 are substantially parallel to one or more masticatory occlusal surfaces of artificial molar teeth 34 and/or artificial bicuspid teeth 36 of the dental arch 28. Hence, the support 10 provides strength to the dental arch 28 in accordance with the masticatory forces that are typically encountered in the different regions.

With reference to FIG. 4A showing a perspective view of part of the support 10, in this embodiment, the artificial teeth 29 of the dental arch are permanently bonded or affixed to the elongate member 12 in predetermined, fixed positions.

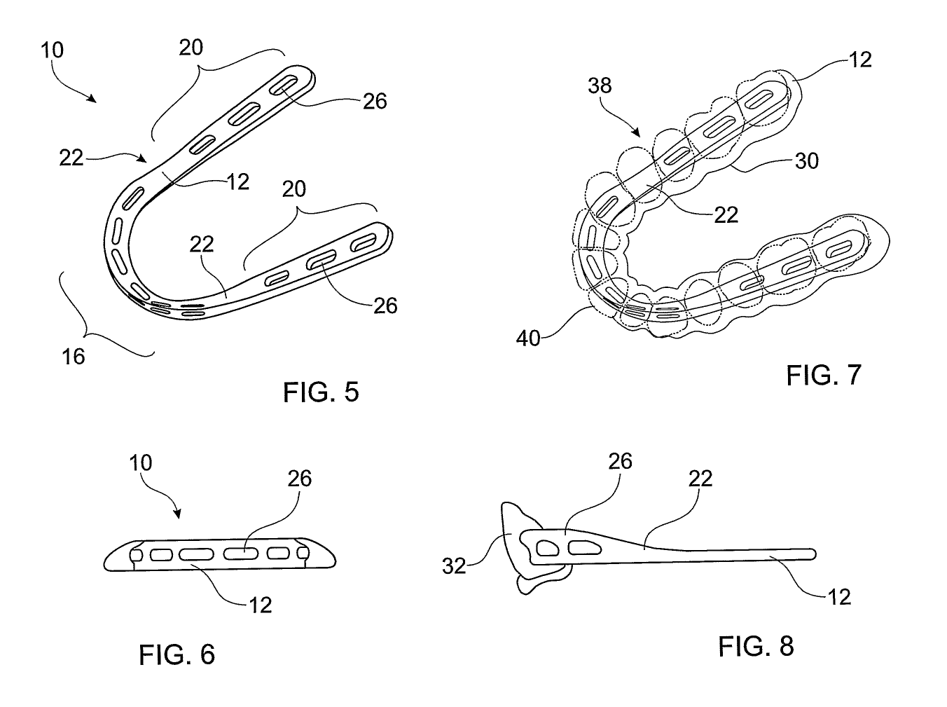

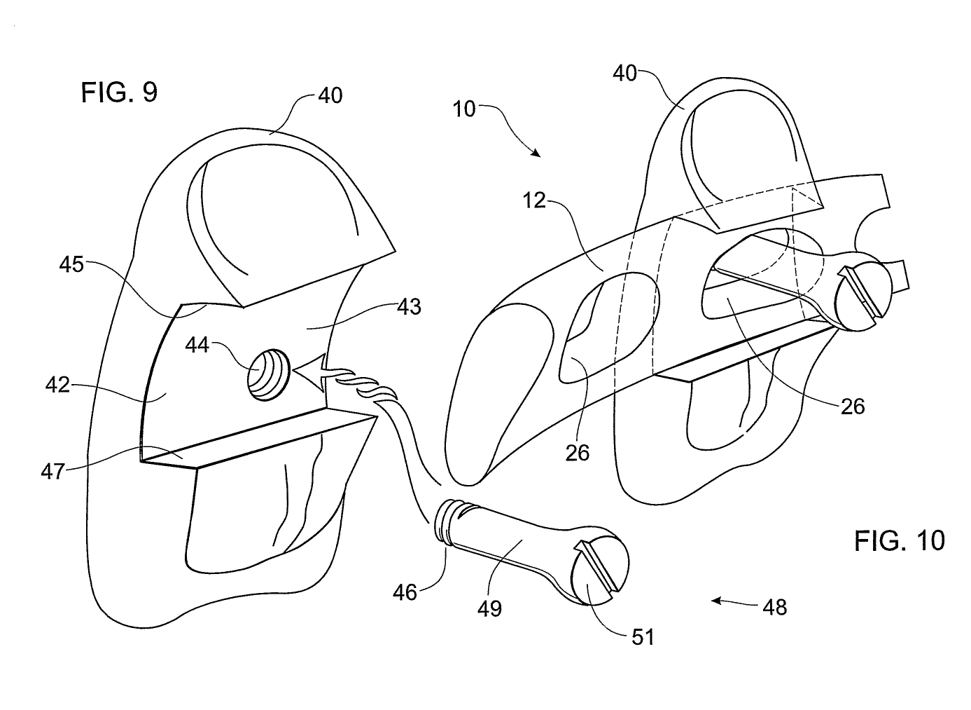

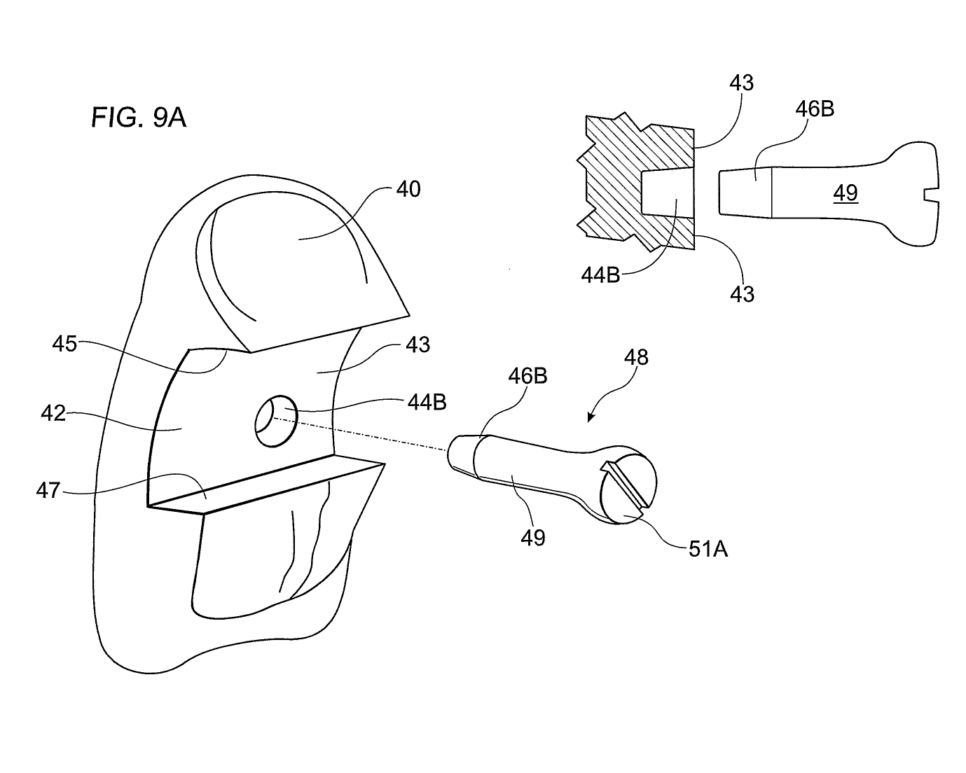

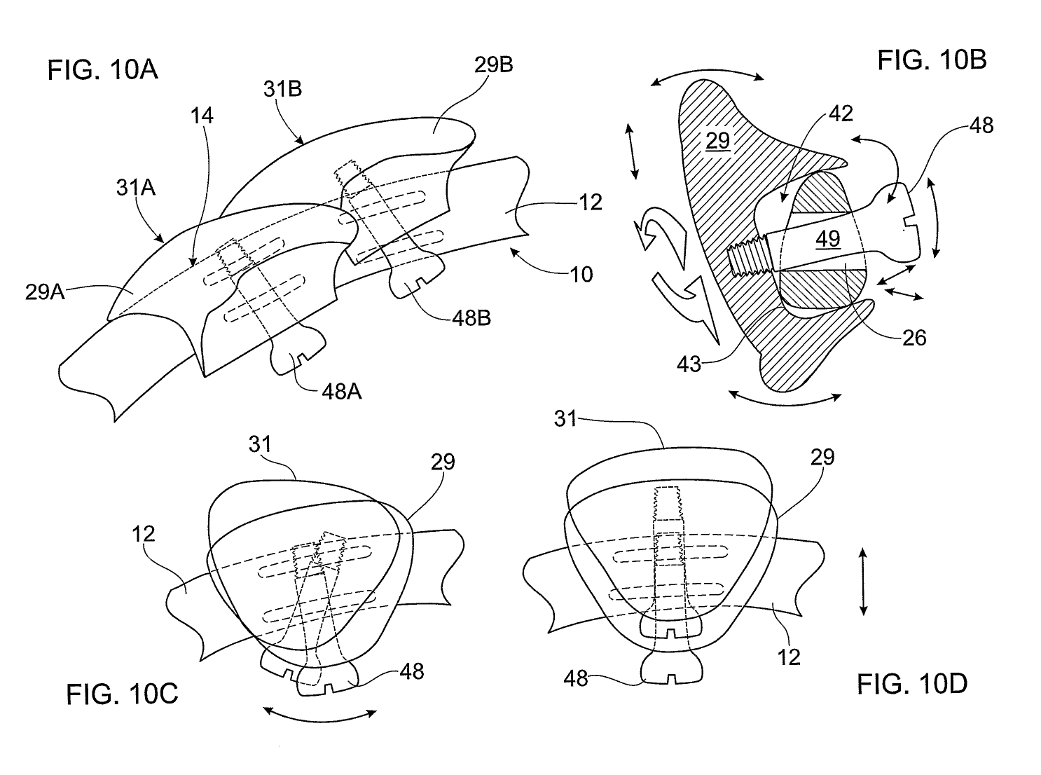

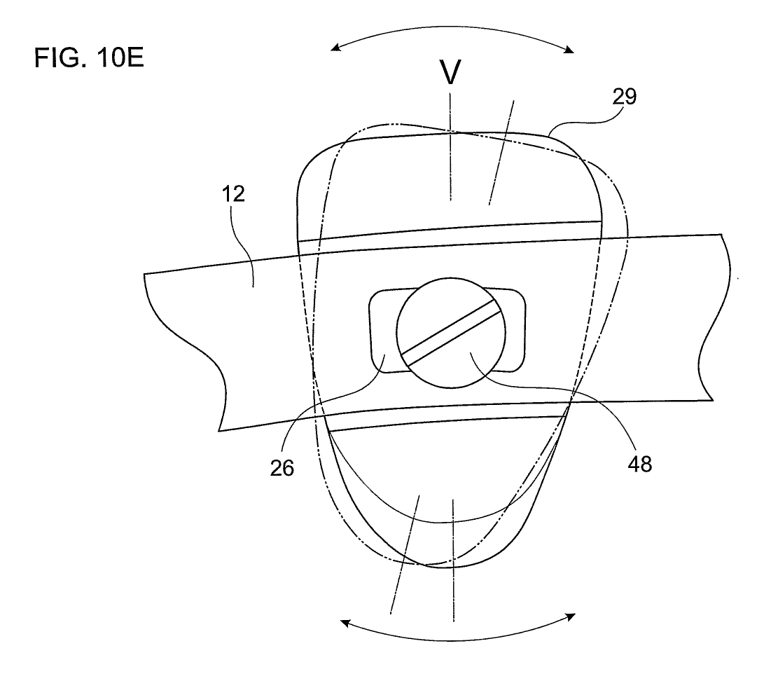

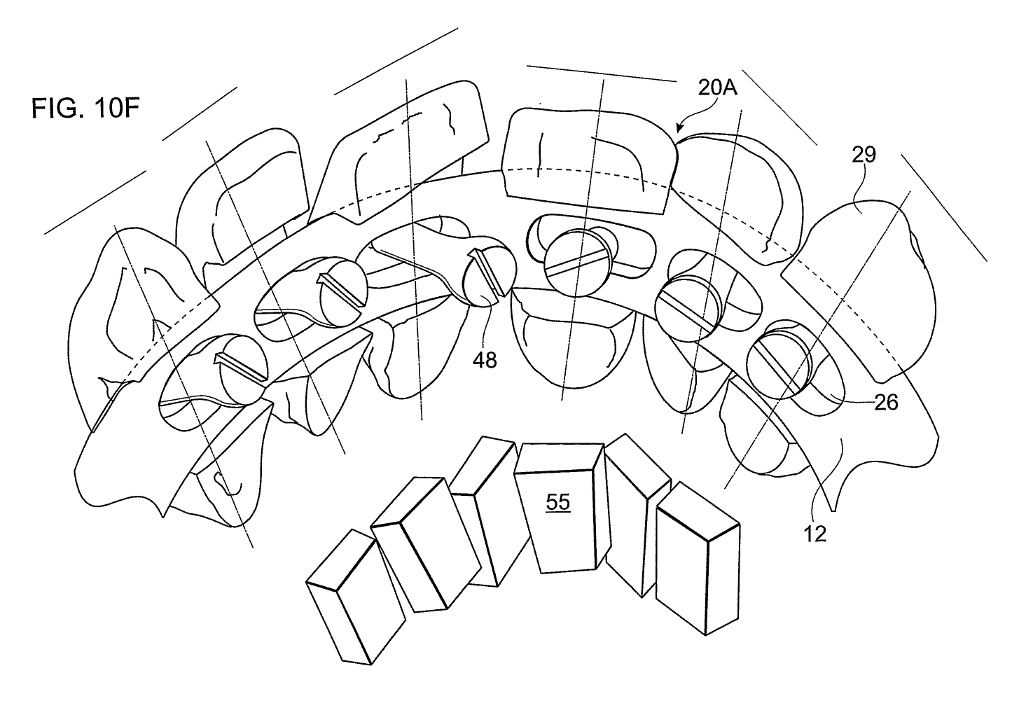

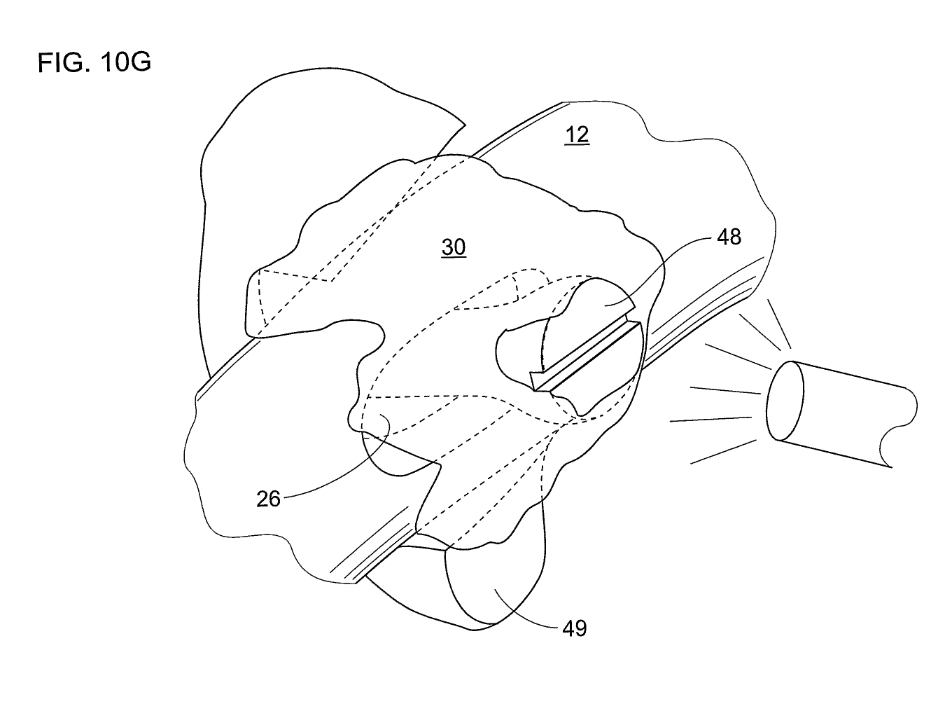

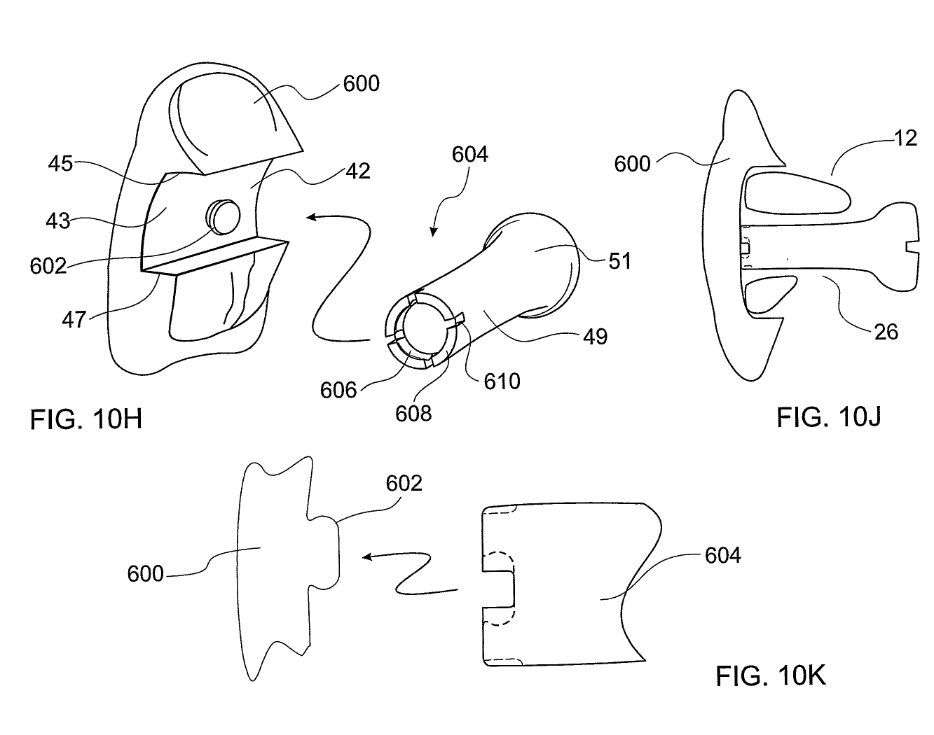

FIGS. 5 and 6 show a perspective view and a rear view respectively of a support 10 for a dental arch in accordance with an alternative embodiment of the present invention. In this embodiment, the support 10 comprises a plurality of apertures 26 in the elongate member 12. In the embodiment shown, apertures 26 are provided in the anterior region 16 and in the posterior regions 20 of the elongate member 12, but not in the transitional regions 13 achieved, for example, by the twists 22 of the elongate member 12. The apertures 26 are provided to loosely affix artificial teeth to the support 10 such that the positions of the artificial teeth are adjustable with respect to the support 10, which will be described in detail in relation to FIGS. 9 and 10.

FIG. 7 shows an upper dental arch 38 according to another embodiment in which at least some of the artificial teeth 40 are affixed to the elongate member 12 using the apertures 26 and fasteners (not shown). Some of the artificial teeth 40, such as those adjacent the transitional regions 13, such as the twist 22 in the elongate member 12, are affixed to the elongate member 12 using acrylic 30 and/or composite bonding material and/or other material.

FIG. 8 shows a single artificial anterior incisor tooth 32 affixed to the anterior portion 16 of the elongate member 12 via one of the apertures 26, with remaining apertures 26 available for further artificial teeth to be attached. It should be appreciated that the support 12 comprising the artificial anterior incisor tooth 32 is for an upper denture and is inverted (pointing upwards) in FIG. 8. A support 12 according to embodiments of the present invention for the lower arch has a similar structure, except that the dimensions will differ from those of the support for the upper arch to suit the smaller dimensions of the lower dentition. For example, the anterior lower dentition is smaller in size than the anterior upper dentition.

Referring to FIGS. 9 and 10, in accordance with the present invention, an artificial tooth 40 comprises a channel 42 in the back of the tooth and a threaded recess 44 for receiving a threaded end 46 of a fastener 48. The fastener 48 can be made of acrylic or metal, such as titanium, although other materials of similar strength can be used. The channel 42 comprises a back wall 43, an upper surface 45 and a lower surface 47 and has a height greater than the height of the elongate member 12 of the support 10. As shown in FIG. 10, according to some embodiments, the artificial tooth 40 is positioned on the support 10 such that part of the elongate member 12 is received within the channel 42 and can abut against the back wall 43, upper surface 45 and lower surface 47, either firmly or loosely. The artificial tooth 40 is held in place on the elongate member 12 via the fastener 48 passing through one of the apertures 26 in the elongate member aligned with the artificial tooth 40 and screwed into the threaded recess 44. The apertures 26 have a width and a height greater than the diameter of a shaft 49 of the fastener 48, but less than a diameter of a head 51 of the fastener 48, not only to allow passage of the fastener 48 through the aperture 26, but also to enable the artificial tooth 40 to be loosely attached in a range of different positions and angles, whilst preventing the tooth 40 from being removed or detached easily. Hence, the vertical positions, the lateral positions and the angles of the artificial teeth are adjustable with respect to the apertures 26 providing a high degree of maneuverability in achieving the desired appearance and anterior tooth position of the dental arch and denture produced therefrom. In the example shown in FIG. 10, an anterior lateral artificial tooth 40 is positioned in a loose format abutting against the front 14 of the elongate member 12.

In alternative embodiments, the recess 44 and the fastener 48 may not be threaded. Instead, the recess 44 can be in the form of a female socket that receives an enlarged end of the fastener 48. The enlarged end can be of a complementary shape to the female socket. In such embodiments, the enlarged end of the fastener 48 can be resilient such that the enlarged end is snap-fitted into, and engaged by, the female socket.

With reference to FIG. 9A, in another embodiment, the recess is in the form of a slightly tapered female socket 44B within the back wall 43 of the artificial tooth 40. The end 46B of the shaft 49 of the fastener 48 is also gently tapered and is sized to be received within and engaged by recess 44B. End 46B is held within the recess 44B, but can be removed by hand by pulling with sufficient force on head 51A, which no longer requires a slot for screwing the fastener 48 into place.

Further examples of the range of different positions and angles in which the artificial teeth 29 can be situated with reference to the support 10 are shown in FIGS. 10A-10F.

FIG. 10A shows two artificial teeth 29A, 29B loosely attached to the elongate member 12 of the support 10 with fasteners 48A, 48B. Tooth 29A is loosely attached with a front surface 31A substantially parallel to the face 14 of the elongate member 12. Tooth 29B is loosely attached with a front surface 31B angled with respect to the face 14 of the elongate member 12.

FIG. 10B shows a side elevation of an artificial tooth 29 loosely attached to the elongate member 12. Shaft 49 of fastener 48 passes through aperture 26 and is secured tightly in the recess 44 of back wall 43 of channel 42. In the embodiment shown in FIG. 10B, the artificial tooth 29 is forwardly inclined with respect to the elongate member 12. The arrows show the various orientations in which the artificial tooth 29 can be moved with respect to the elongate member 12.

FIG. 10C illustrates how the artificial tooth 29 can be moved with respect to the elongate member 12 to vary the angle of the front facial surface 31 of the tooth 29 with respect to the face 14 of the elongate member 12.

FIG. 10D shows how the artificial tooth 29 can be moved forwards and backwards with respect to the elongate member 12 to vary how much the front surface 31 of the tooth 29 protrudes from the elongate member 12.

FIG. 10E illustrates how the artificial tooth 29 can be rotated about an axis of the fastener 48 to vary the angle of the tooth 29 with respect the vertical V and with respect to the elongate member 12.

FIG. 10F shows part of the support 10 and six artificial anterior teeth 29 held loosely in place on the elongate member 12 by their respective fasteners 48. The artificial teeth 29 are shown in a range of positions with respect to the elongate member 12. Reference lines highlight the degree of rotation of each tooth with respect the vertical and the angles of the front surfaces 31 with respect to the elongate member 12. A range of angles of inclination and different degrees of protrusion are also illustrated as well as an overlap 29A between two adjacent artificial teeth 29. The blocks 55 in the foreground illustrate schematically the position and orientation of each tooth 29. This vast range of orientations allows almost any position of the artificial anterior teeth 29 desired by the patient or practitioner.

With reference to FIG. 10G, once the desired position of the tooth 29 has been determined, it can be temporarily stabilized or fixed in its preferred position with wax, or fixed more permanently in position with either self cure acrylic or UV light cured composite material 30 to maintain the preferred aesthetics from both the patient's and the practitioner's perspective.

FIGS. 10H, 10J and 10K show alternative embodiments of the artificial teeth and fasteners. Artificial tooth 600 comprises many of the features of the earlier embodiments described herein, such as channel 42 comprising back wall 43, upper surface 45 and lower surface 47 wherein the channel 42 has a height greater than the height of the elongate member 12 of the support 10. However, in this embodiment, a male projection 602 extends from the back wall 43 rather than back wall 43 comprising the recess 44 of previous embodiments. Artificial tooth 600 is held in place on the elongate member 12 via the fastener 604 passing through one of the apertures 26 in the elongate member 12 aligned with the artificial tooth 600. Apertures 26 have a width and a height greater than the diameter of the shaft 49 of the fastener 604, but less than a diameter of the head 51 of the fastener 604. In this embodiment, an end of the fastener 604 opposite the head 51 comprises a recess or female socket 606 for engaging male projection 602 of artificial tooth 600. Male projection 602 can comprise an enlarged end of a substantially complementary shape to the female socket 606 of the fastener 604. In such embodiments, the female socket 606 can be resilient such that the enlarged end is snap-fitted into, and engaged by, the female socket 606. A wall 608 of the female socket 606 can comprise one or more notches or cut-outs 610 to facilitate the resilient engagement of the male projection 602 by the female socket 606. The length of the male projection 602 and therefore the depth of the female socket 606 can vary between embodiments. According to some embodiments, the male projection 602 extends from the back wall 43 by at least about 1 mm and therefore the depth of the female socket 606 is at least 1 mm to accommodate the male projection 602.

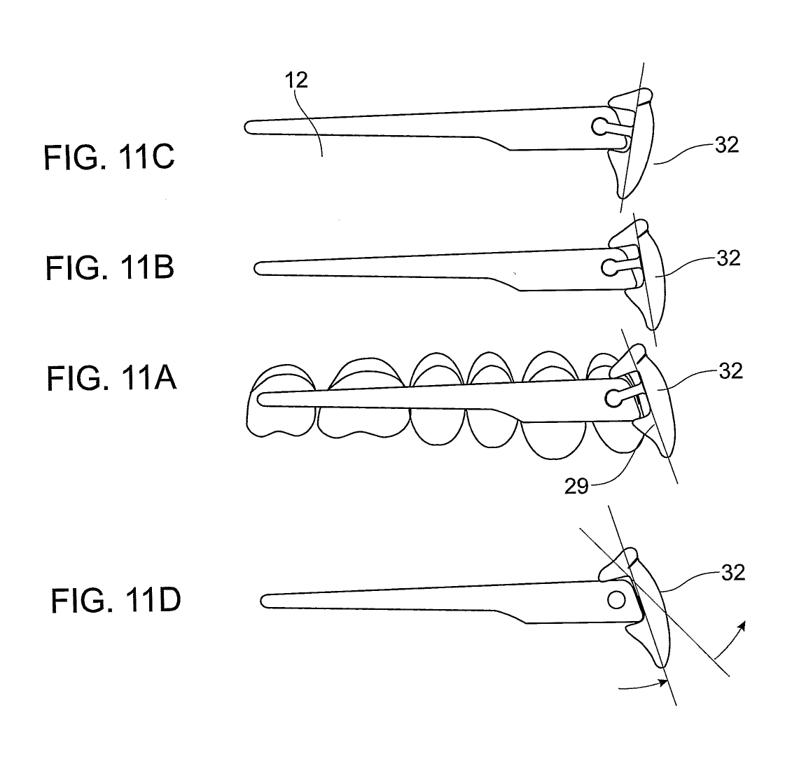

Referring to FIGS. 11A-11D, according to some embodiments, the angles of inclination of the artificial teeth 29 with respect to the elongate member 12 are adjustable, showing vertical deflective positions, vertical angular inclinations and mesio-distal-overlaps, as shown in FIG. 10F as 29A. FIG. 11A shows a dental arch comprising artificial teeth 29 attached to the elongate member 12 on a far side and no artificial teeth affixed to the near side of the elongate member 12. An artificial incisor tooth 32 is affixed to a front region 16 of the elongate member 12 such that the tooth 32 is inclined at an acute angle with respect to the substantially horizontal elongate member 12. Hence, the artificial incisor tooth 32 is angled labialy with the incisal tip prominently forward. In FIG. 11B, the artificial incisor tooth 32 is substantially vertical and incisorly tipped inwardly or lingualy, compared to 11A. In FIG. 11C, the artificial incisor tooth 32 is inclined and even more incisorly tipped inwardly or lingually than 11A or 11B. The range of movement can be placed incisorly even more predominately forward than as shown in FIG. 11A if preferred, as shown in FIG. 11D.

The dental arch 28 is provided in a range of sizes to fit different mouth sizes. The dental arch is at least provided in small, medium and large sizes and can also be provided in further sizes as discussed further hereinafter. The dental arch 28 is also provided in a range of shapes to match the general shape of the mouth of the patient. The dental arch 28 can be, for example, generally square, round (ovoid), tapered or other shapes depending on the degree of curvature of the jaw. The shape of the dental arch 28 is based on the support 10 of the same shape. For example, a tapered dental arch will be based on a support having tapered shaped teeth and so on.

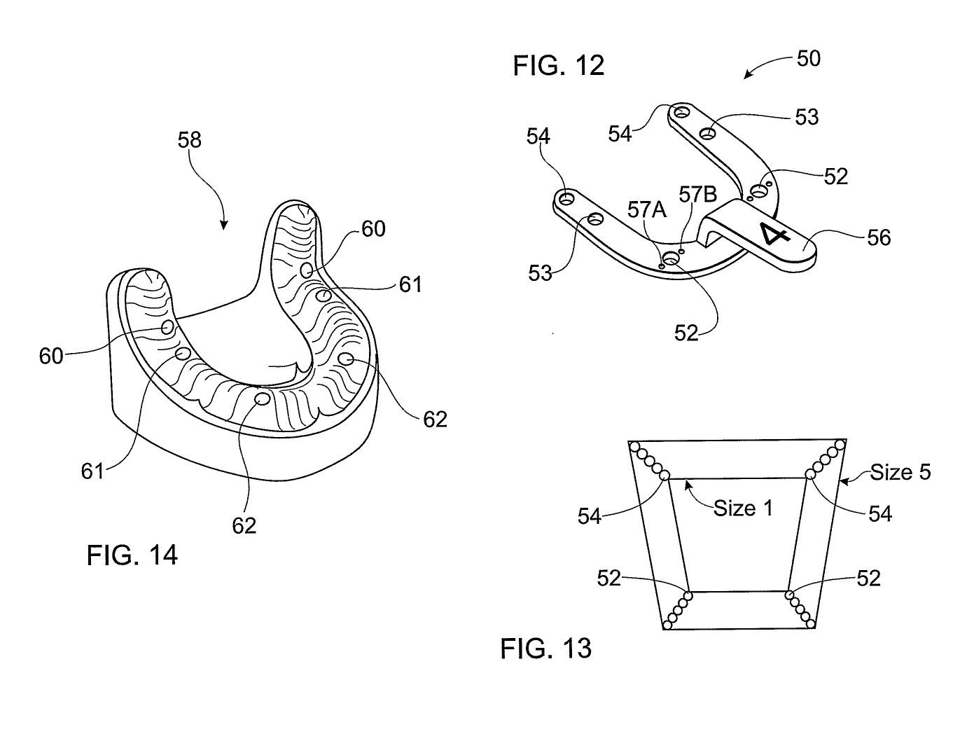

In accordance with other aspects of the present invention and with reference to FIG. 12, an arcuate member 50 is provided for assessing the size of the dental arch. The arcuate member 50 can be formed from transparent plastics material that is capable of being sterilized. The arcuate member 50 comprises a pair of anterior apertures 52 in the left and right anterior region closest to a handle 56 to indicate positions of the cuspid teeth left and right. The arcuate member 50 also comprises at least one pair of posterior apertures 53 in the left and right posterior region to indicate positions of molar teeth. In particular, the pair of second apertures 53 indicate the positions of the mesio-labial buckle cusps of the first molar teeth left and right. According to some embodiments, as shown in FIG. 12, the arcuate member 50 can comprise a second pair of posterior apertures 54 in a more posterior region to indicate positions of the second molar teeth left and right. In particular, the second pair of posterior apertures 54 are posterior of the first pair of posterior apertures and indicate the positions of the center fossa of the second molar teeth. According to some embodiments, the arcuate member 50 comprises anterior apertures 52 and posterior apertures 54. The handle 56 extends from the arcuate member 50 to facilitate use and the arcuate member can be used directly on a patient's mouth or on a model of the patient's mouth.

FIG. 12 shows one of a series of arcuate members 50 used in assessing the size of the dental arch. Each arcuate member corresponds to a particular size of dental arch and in FIG. 12 the arcuate member 50 is marked with a “4” indicating a size 4 arcuate member. With reference to the scheme shown in FIG. 13, the relative positions of the pair of anterior apertures 52 and the pair of posterior apertures 54 on each arcuate member correspond to the size of the dental arch. For example, in a scheme that comprises, for example, five dental arch sizes, there are five different arcuate members. For the smallest size, e.g. size 1, the pair of anterior apertures 52 and the pair of posterior apertures 54 of the arcuate member 50 are represented by the innermost circles shown in FIG. 13. For the largest size, e.g. size 5, the pair of anterior apertures 52 and the pair of posterior apertures 54 of the arcuate member 50 are represented by the outermost circles shown in FIG. 13. The intermediate sizes correspond to the circles in between the smallest and largest sizes. According to some embodiments, in FIG. 13 each circle is a horizontal distance of 1 mm and a vertical distance of 1 mm from an adjacent circle. However, other horizontal and/or vertical spacings can be used.

FIG. 14 shows a model 58 of the lower dentate ridge and positions 60 of the second molar teeth, positions 61 of the mesio-buckle cusps of the first molar teeth and positions 62 of the cuspid teeth.

It will be appreciated that the scheme is not limited to five different dental arch sizes. For example, the scheme can comprise three, four or more than five arcuate members 50 corresponding to a scheme comprising three, four or more than five dental arch sizes. In a scheme comprising three sizes, the sizes can correspond to small, medium and large.

According to some embodiments, the arcuate member 50 comprises one or more indicia 57A, 57B adjacent each anterior aperture 52. Alignment of one of the indicia 57A, 57B with the cuspid teeth is indicative of a tapered arch form or a square arch form. For example, if the indicium 57A aligns with the cuspid teeth, this is indicative of a square arch form. If the indicium 57B aligns with the cuspid teeth, this is indicative of a tapered arch form. According to some embodiments, the indicia 57A, 57B are in the form of apertures in the arcuate member 50.

Hence, another aspect of the present invention is a system for assessing a size of a dental arch, the system comprising a series of arcuate members 50, each arcuate member comprising a pair of anterior apertures 52 in the left and right anterior region to indicate positions of cuspid teeth and at least one pair of posterior apertures 53, 54 in the left and right posterior region to indicate positions of molar teeth, wherein the relative positions of the pair of anterior apertures 52 and the pair of posterior apertures 53, 54 of each arcuate member 50 correspond to a size of the dental arch. In particular, the pair of posterior apertures 53 indicate the positions of the mesio buckle cusps of the first molar teeth left and right. As described above, according to some embodiments, each arcuate member 50 in the series can also or alternatively comprise a second pair of posterior apertures 54 in a more posterior region to indicate positions of the second molar teeth left and right. In particular, the second pair of posterior apertures 54 are posterior to the first pair of posterior apertures 53 and indicate, for example, the positions of the mid-center fossa of the second molar teeth.

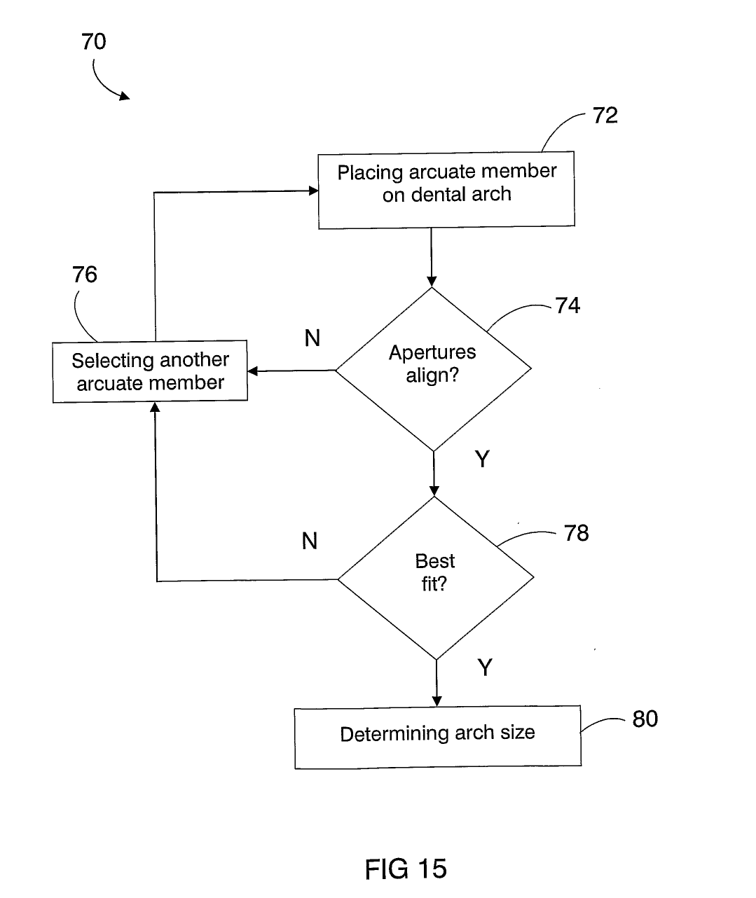

With reference to FIG. 15, utilizing the aforementioned system, another aspect of the invention is a method 70 of determining a size of a dental arch. The method 70 includes at 72 placing one of a series of the aforementioned arcuate members 50 on the dental arch. At 74, the method includes determining whether the pairs of anterior apertures 52 and the first and/or second pair of posterior apertures 53, 54 align with the positions of the cuspid teeth and the molar teeth respectively. This can include aligning the indicia 57A, 57B as described above to determine the shape of the arch. If not, the method includes at 76 selecting another size of arcuate member 50 and repeating steps 72 and 74. If the pairs of anterior and first and/or second posterior apertures 52, 53, 54 align with the positions of the cuspid teeth and the molar teeth, the method includes at 78 determining whether the arcuate member 50 is the best fit. If not, at 76 the method includes selecting another size of arcuate member 50 and repeating steps 72, 74 and 78. If the arcuate member 50 is the best fit, the method includes at 80 determining the size and shape of the dental arch based on the arcuate member that best matches the positions of the molar teeth and the cuspid teeth. The colour of the artificial teeth to be used can also be determined at this stage.

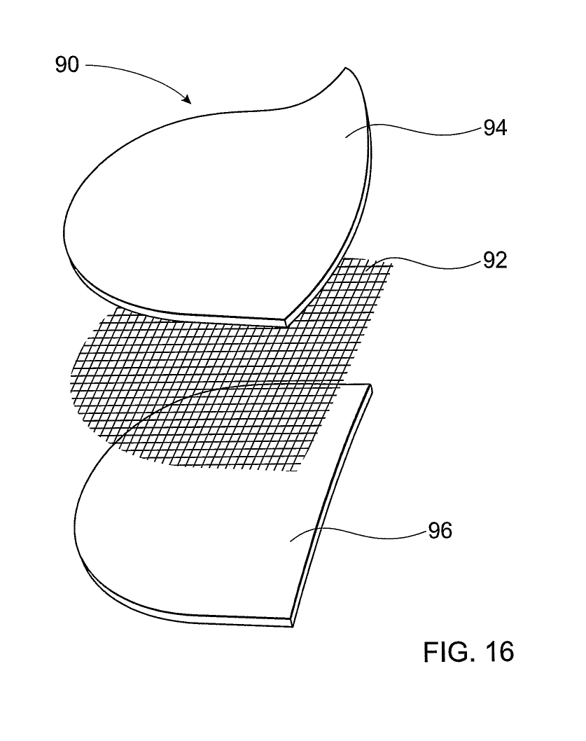

With reference to FIG. 16, another aspect of the present invention is a non-cured, flexible composite sheet 90 with flexible strengthening mesh for making more resilient and stronger dentures. The exploded view in FIG. 16 shows the components of an embodiment of the flexible composite sheet 90, which comprises a composite material, such as flexible acrylic, embedded with a biocompatible reinforcing mesh 92, such as biocompatible fibreglass. Although the flexible composite sheet 90 will be provided as a single unit ready to use, the flexible composite sheet 90 can be made by compressing the reinforcing mesh 92 between two layers 94, 96 of composite material, as shown in FIG. 16. As described in further detail hereinafter, the composite material 94, 96 is currently in use in the manufacture of dentures and the reinforcing mesh 92 of the novel flexible composite sheet 90 adds further strength to denture bases.

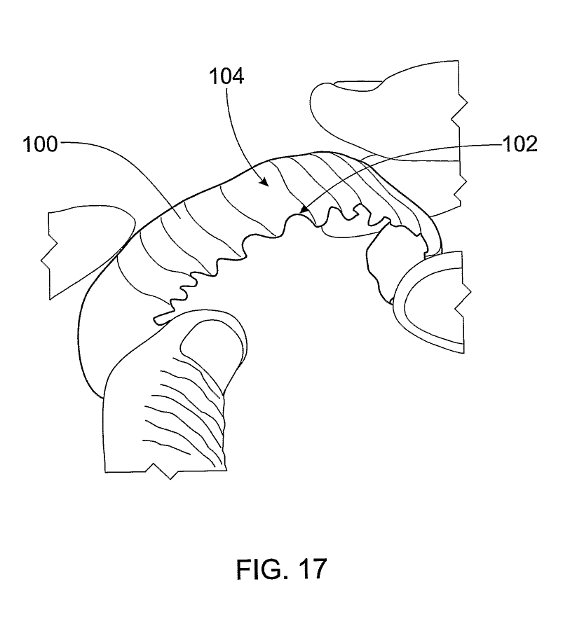

With reference to the embodiment shown in FIG. 17, a further aspect of the invention is a length of flexible, acrylic composite material 100 in the form of a dental apron. The dental apron comprises a series of arcuate cut-outs 102 for alignment with the necks of the artificial teeth 29 of a conventional pre finished dental set up, or composite collars surrounding the dental arches of a pre-finished denture. For example, the arcuate cut-outs 102 can also be aligned with the cervical regions of the artificial teeth 29. The dental apron has a semi-cured outer composition and therefore has some outer layer stiffness. The dental apron comprises a plurality of raised or embossed regions 104 called festooning simulating the appearance of the gums and its underlying root structure. The dental apron can be used for instant festooning of the labial and buckle regions of the denture, i.e. when blending in the artificial teeth of the dental arch with the artificial gum using composite material to create an authentic and natural appearance. The dental apron is provided in different sizes to suit to the different size arches. The dental apron improves efficiency in manufacturing the denture by reducing the time taken normally to festoon and characterize the labial and buckle portions of the denture by hand during manufacturing.

The dental apron can also be formed of rubber material for a reusable format or of wax material for the conventional wax-up format, having a series of arcuate cut-outs 102 for alignment with artificial teeth for use in festooning wax rims around the dentition arches already set in the desired position. The dental aprons for these formats are also provided in different sizes to suit to the different size arches. The dental apron here, once again improves efficiency in manufacturing the denture by reducing the time taken normally to festoon and characterise the denture by hand during manufacturing.

The dental apron can also be self made by pressing the flexible acrylic composite material 100 or wax material on a mold in the form of a festooning module in accordance with another aspect of the present invention. The festooning module is an elongate metal strip having a negative surface pattern that imprints the embossed regions 104 on the flexible acrylic composite material 100 or rubber or wax strip. Hence, a labial apron is created having festooned markings or imprints ready for use.

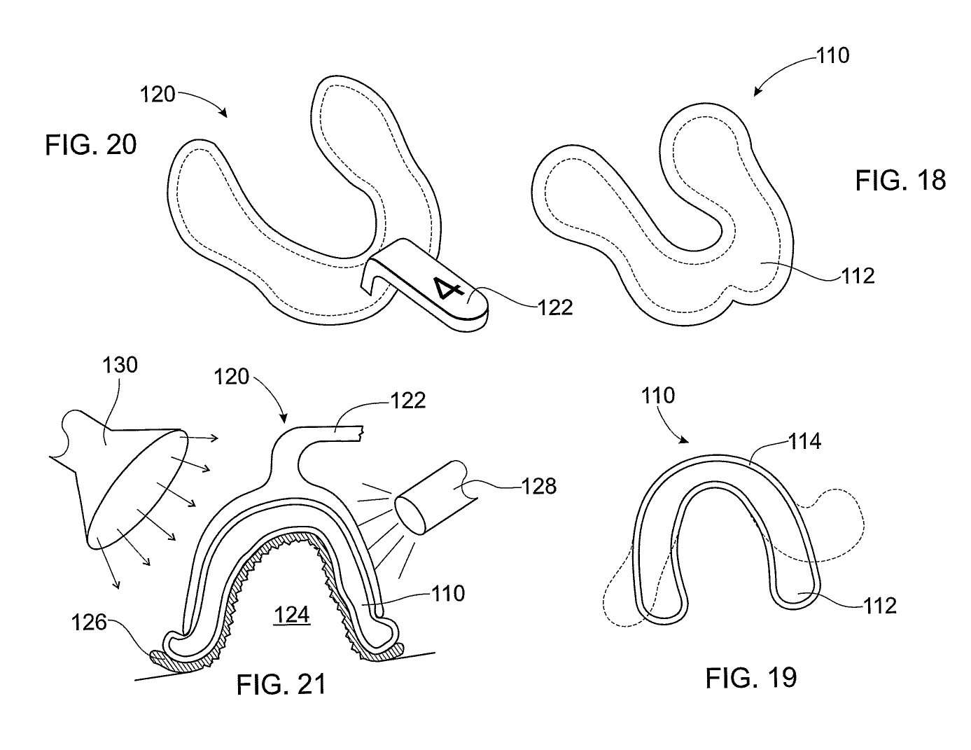

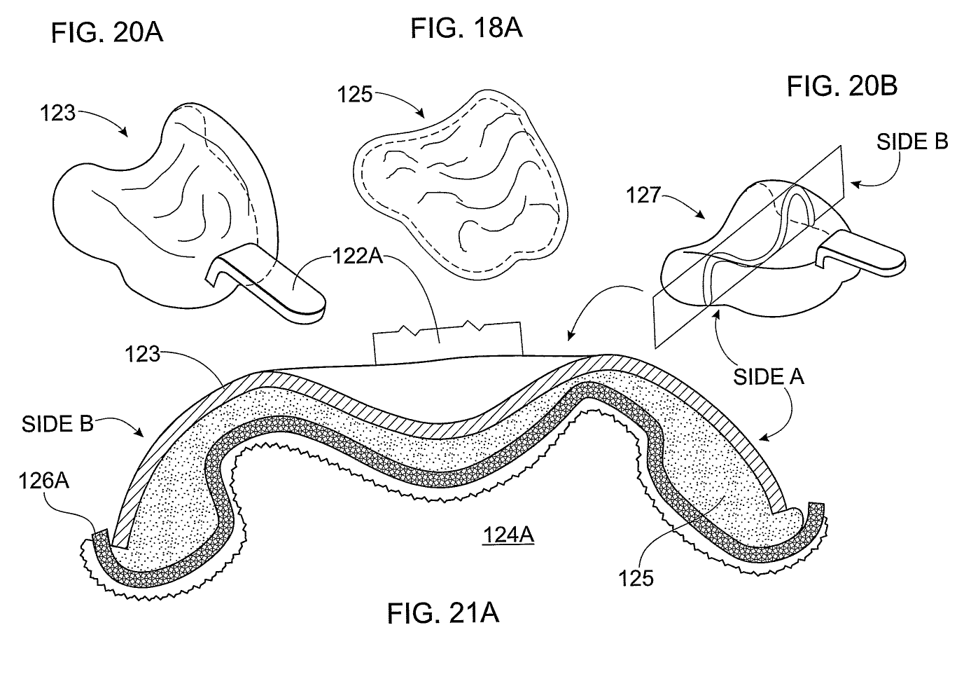

Referring now to FIGS. 18 and 19, a yet further aspect of the invention is a flexible, cushioning insert 110 for use in taking molds of oral ridges. According to one embodiment, the insert 110 has an arcuate shape approximating to the shape of an oral arch of the lower ridge and comprises a super clear gel 112 in a sealed clear outer layer 114. As shown in FIG. 19, the insert 110 of the lower ridge has a substantially U-shaped cross section and is provided in a range of sizes to fit a range of correspondingly shaped clear trays described hereinafter. For example, with reference to the aforementioned size schemes for dental arches, the inserts 110 can be provided in three sizes, such as small, medium and large, four sizes, five sizes, such as sizes 1-5 or another number of sizes. The dotted lines in FIG. 19 illustrate the flexible nature of the insert 110 at the lingual and labial portion that fit in and around the lingual, labial, and buckle oral sulcuses.

FIG. 20 shows a lower tray 120 for taking molds of lower oral ridges. The tray can be sterilized and can be made of any suitable material such as clear, high impact plastics material and is preferably highly transparent in nature. The tray 120 has an arcuate shape approximating to the shape of a dental arch and comprises a handle 122 to facilitate use of the tray. The tray 120 is provided in a range of sizes in accordance with one of the aforementioned size schemes. FIG. 20, for example, shows a size 4 tray used in a scheme comprising five sizes.

FIG. 21 shows a cross sectional view of the insert 110 shown in FIG. 18 and the tray 120 shown in FIG. 20 being used to take an impression of an oral ridge 124. The lower tray 120 has a substantially U-shaped cross section and FIG. 21 shows the oral ridge 124 of a patient with a layer of composite material 126 over the oral ridge 124. The insert 110 is placed in the tray 120 and lies between the composite material 126 and the tray 120. The flexible, cushioning insert 110 ensures that the composite material 126 is snuggly held against the oral ridge 124 to achieve a close fitting and faithful impression of the oral ridge 124 without distortion of the oral ridge and without pain or injury to the patient. The flexible, cushioning insert 110 prevents excessive pressure being applied to the tissues that would distort and displace the ridges dimensions. A hand held UV light 128 is used to cure the composite material 126 to a solid consistency in the patient's mouth to retain the impression of the oral ridge 124. Once removed from the patient's mouth, a larger UV light 130 or UV appliance can be used to completely cure the composite material 126 such that it sets completely.

With reference to FIGS. 20A and 20B, it should be appreciated that an upper tray 123 made of the same material as the lower tray 120 is also provided for taking molds of the upper dental ridge and upper palate. The upper tray 123 comprises a handle 122A to facilitate use. The upper tray 123 is shaped to fit the upper dental ridge and the upper palate and is provided in a range of sizes in accordance with one of the aforementioned size schemes.

With reference to FIG. 18A, a flexible, cushioning insert 125 having the same characteristics as the insert 110 described above in relation to FIGS. 18 and 19 is provided for use with the upper tray 123 for taking molds of the upper oral ridge and upper palate.

FIG. 21A shows a cross sectional view of the insert 125 shown in FIG. 18A and the tray 123 shown in FIG. 21A being used to take an impression of an oral ridge and upper palate 124A. The upper tray 123 has a substantially M-shaped cross section and FIG. 21A shows a layer of composite material 126A over the oral ridge and upper palate 124A. The insert 125 is placed in the upper tray 123 and lies between the composite material 126A and the tray 123. The flexible, cushioning insert 125 ensures that the composite material 126A is snuggly held against the upper oral ridge and upper palate 124A to achieve a close fitting and faithful impression of the upper oral ridge and palate 124A without distortion of the oral ridge and without pain or injury to the patient. The flexible, cushioning insert 125 prevents excessive pressure being applied to the tissues that would distort and displace the ridge dimensions. A hand held UV light 128 is used to cure the composite material 126A to a solid consistency, in the patient's mouth to retain the impression of the oral ridge 124A. Once removed from the patient's mouth, a larger UV light 130 or UV appliance can be used to completely cure the composite material 126A such that it sets completely.

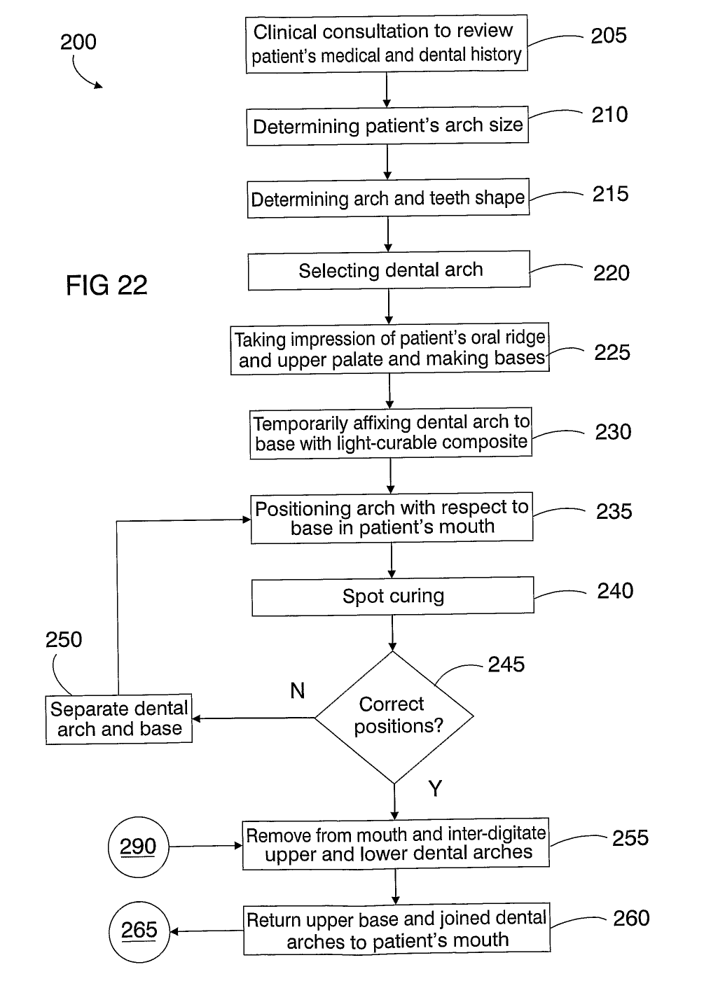

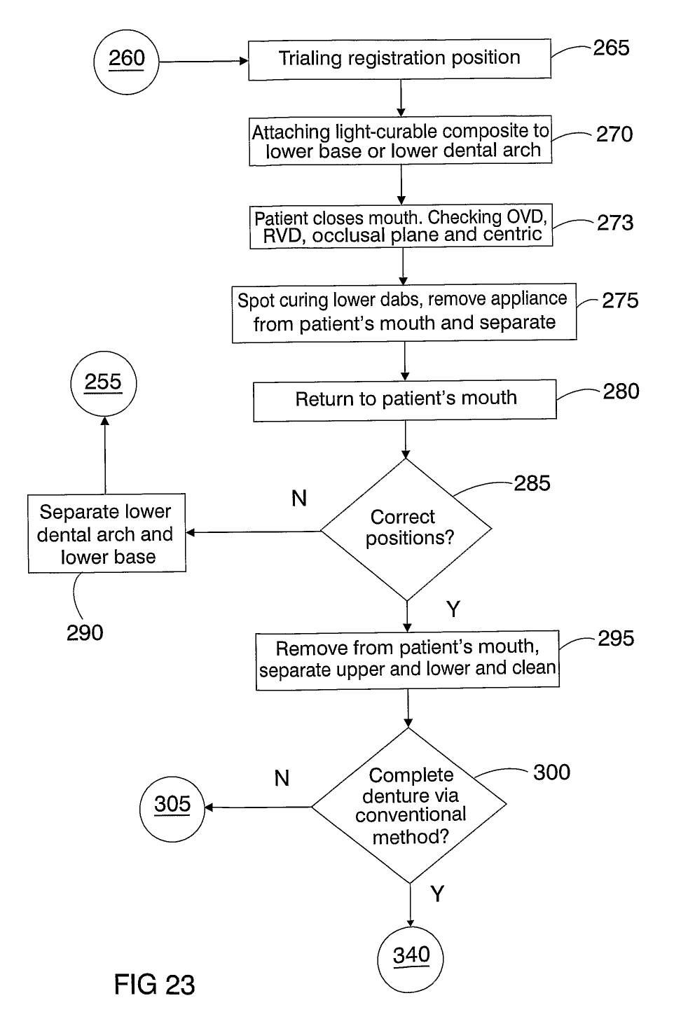

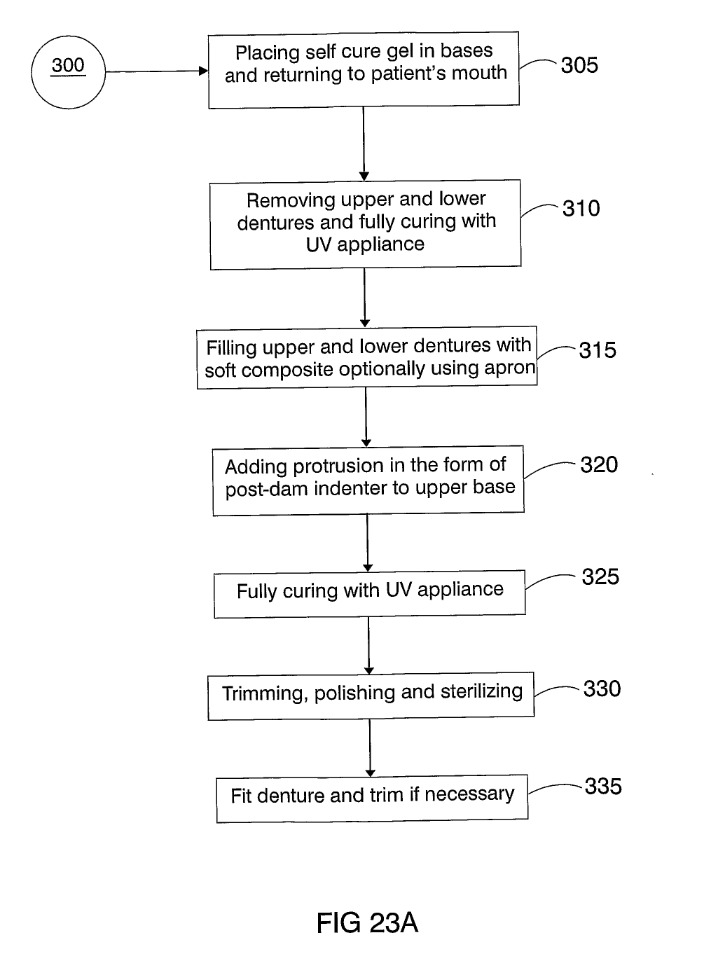

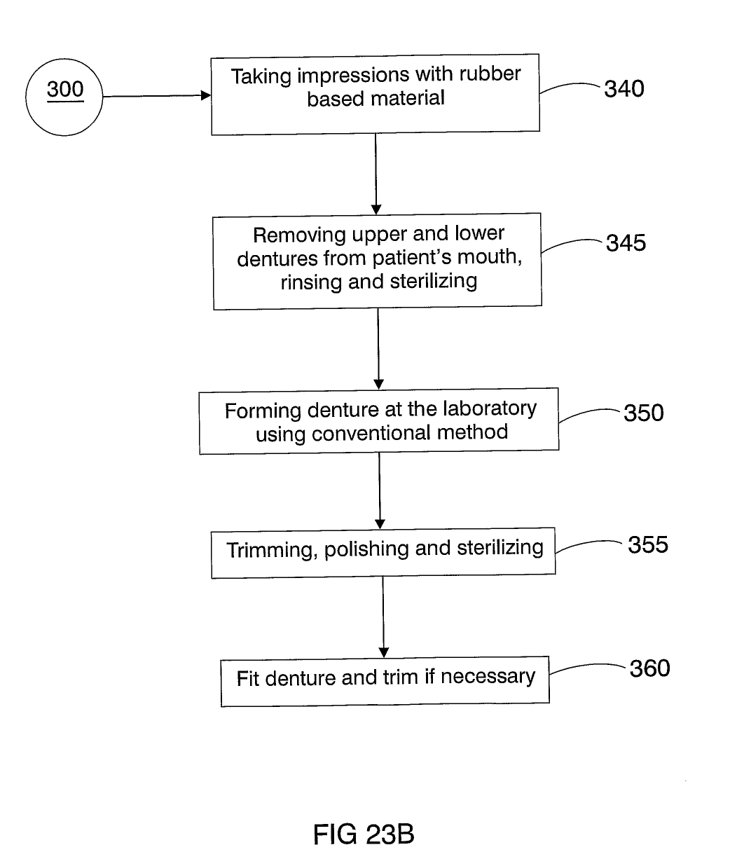

Methods of manufacturing a denture in accordance with embodiments of the present invention will now be described with reference to the general flow diagram shown in FIGS. 22 and 23.

Referring to FIG. 22, a method 200 of manufacturing a denture includes at 205 a clinical consultation between the patient and the dental practitioner to review the patient's medical and dental history.

At 210, the method 200 includes determining the size of the patient's arch using the aforementioned system comprising the series of arcuate members 50 as described above with reference to FIGS. 12-15. The patient's arch size can be determined to be small, medium or large, if a scheme comprising three sizes is being used, or an intermediate size, for example, size 4, if another scheme is being used, such as a scheme with five sizes 1-5.

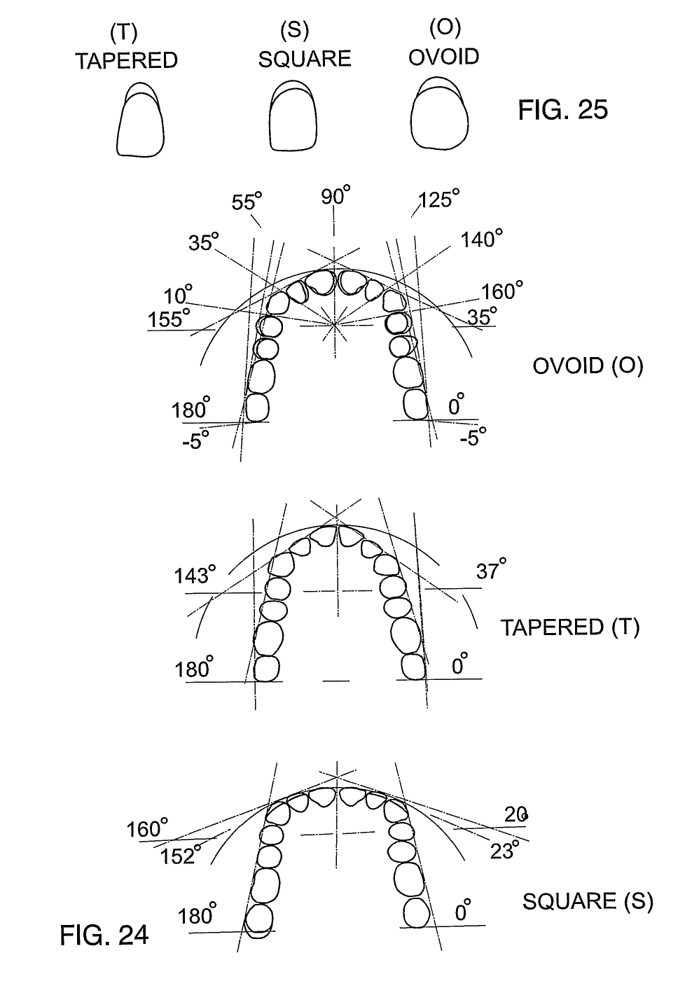

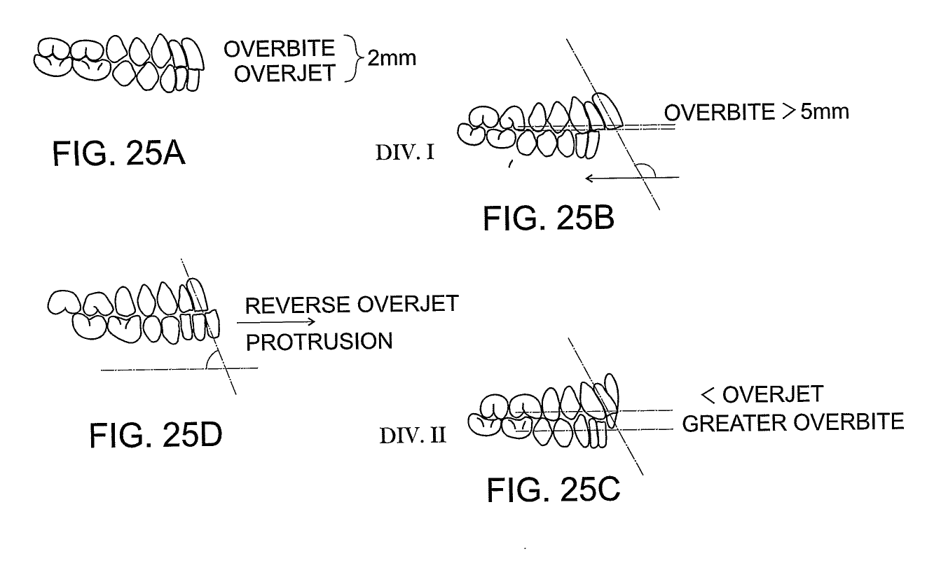

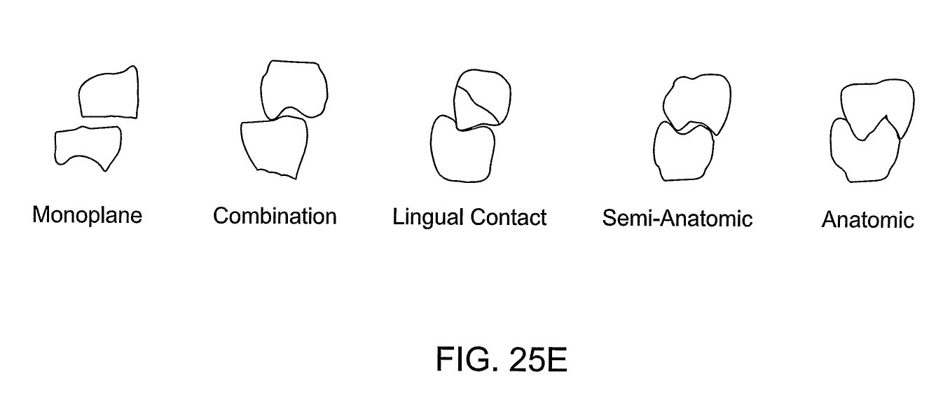

The method includes at 215 determining the patient's arch shape, such as tapered, square or ovoid. A skilled denture practitioner can determine the patient's arch shape by eye or it can be determined with reference to a chart showing a range of arch shapes, as shown in FIG. 24. FIG. 24 shows different arch shapes for one particular size. Other sizes, shapes and formats are also available, and FIG. 24 is only one example. At 215, the dental practitioner, in consultation with the patient, can also determine the general shape of the patient's teeth, which can be tapered, square or ovoid. Examples of such teeth shapes are shown in FIG. 25. The teeth can also be rectangular, narrow rectangular or asymmetrically tapered. The appropriate colour or shade of teeth can also be determined.

At 220, the method includes selecting the particular dental arches 28 for the upper and lower bases from which the denture will be made. In addition to the selected dental arches being of the correct size and shape, it will also comprise the appropriate size, shape and colour or shade of teeth for the patient. According to some embodiments, this process includes ascertaining the patient's occlusal vertical dimension (OVD) and rest vertical dimension (RVD).

With reference to FIGS. 25A-25D, the method also includes determining the patient's occlusion, classification and bite, which are categorized in three classes. As shown in FIG. 25A, Class I is a normal occlusion with an overbite and over jet varying between 1-3 mm. FIG. 25B shows a normal occlusion where the overbite is greater than 3 mm. Class II is a post-normal occlusion wherein the over jet is greater than the overbite, as shown in FIG. 25C. Class III is a pre-normal occlusion with a reverse over jet whereby the incisors can meet edge-to-edge, as shown in FIG. 25D. The dentition can be a flat cusp, a semi high cusp or a physiologically natural cusp, which is determined by the available height or degree of atrophy of the residual oral ridges 124 of the lower.

The dental arches are also made with a cross bite occlusion for patients with that situation, whereby the lower mandible is larger on one side and forces the posterior teeth on that side to be positioned more buckley than the upper buckle arch. The upper buckle cusps fit into the centre fossas of the posterior lower dentition where normally they would fit and interdigitate buckley to the buckle posterior lower dentition.

With reference to FIG. 25E, the dental arches according to embodiments of the present invention can be shaped to accommodate the different types of balanced occlusion in a flat plane, as shown in FIG. 25E, such as monoplane, combination, lingual contact, semi-anatomic or anatomic. Alternatively, the dental arches according to embodiments of the present invention can be shaped to accommodate different types of curvature of the occlusal plane, such as the curve of Spee, the curve of Wilson and the curve of Monson.

At 225, the method includes taking an impression of the patient's residual oral ridge 124 and upper palate. According to some embodiments, this can be achieved using the soft composite flexible composite sheet 90 shown in FIG. 16 and the gel inserts 110, 125 and upper and lower trays 120, 123 shown in FIGS. 18-21, 18A, 20A, 20B and 21A. The flexible composite sheet is trimmed for the patient's upper and/or lower ridges as required. Usually, both an upper and a lower are required because the patient requires a full maxillary and mandibular denture. According to some embodiments of the method 200, the composite material is molded directly onto the patient's residual oral ridge 124 and upper palate and cured using ultraviolet light to produce instant rigid upper and lower bases and then trimmed with a bure to suit appropriate oral fit and extensions, without the conventional impression materials used for molds to be made.

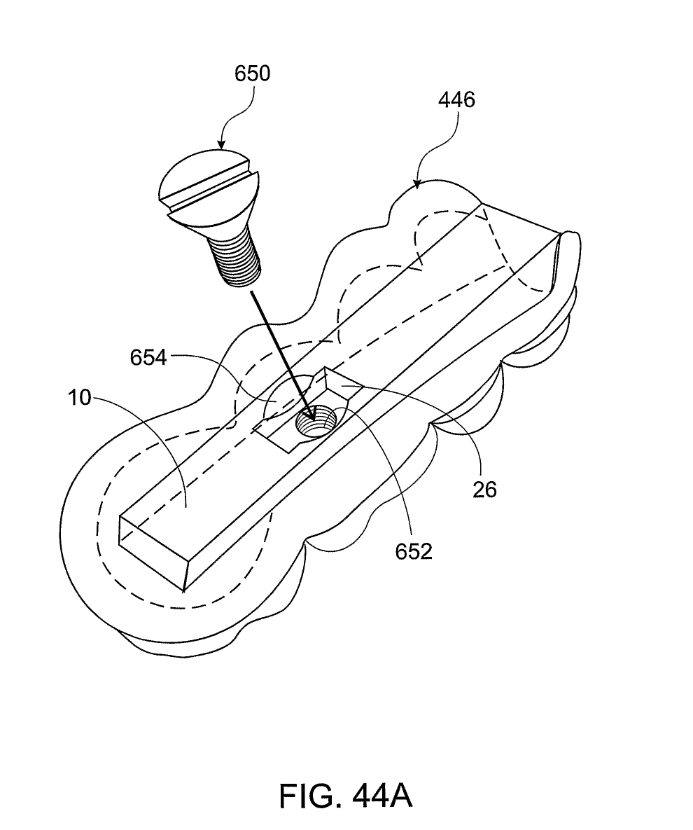

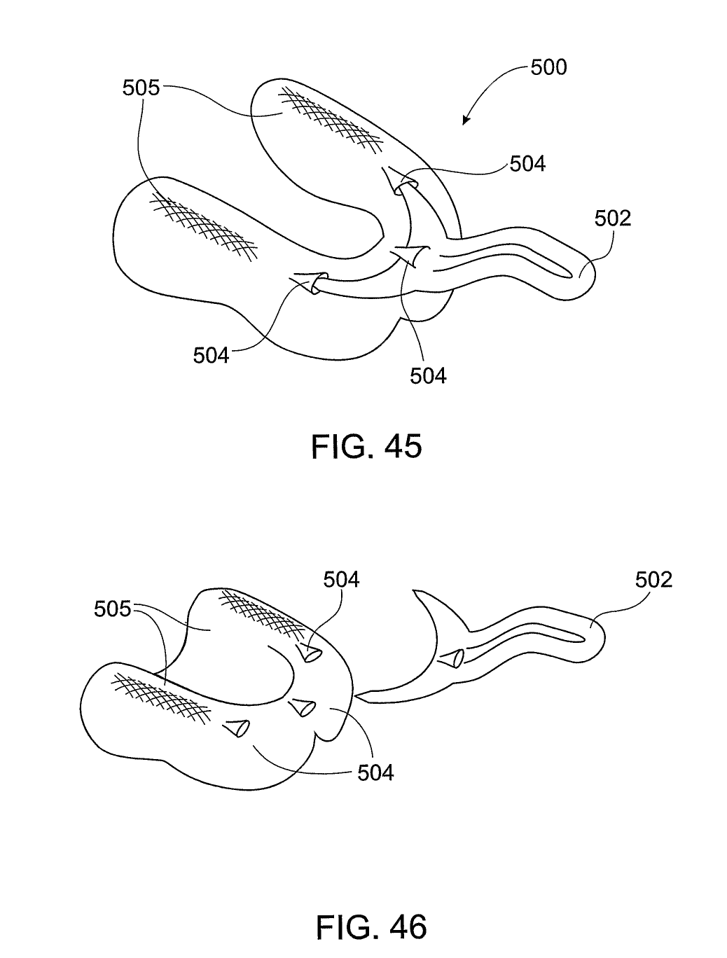

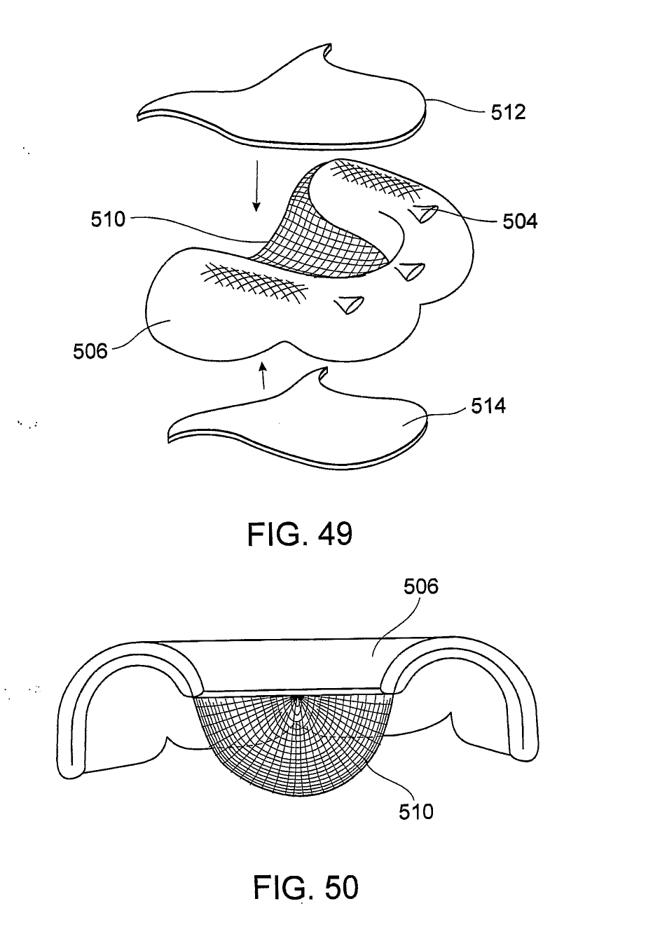

At this point, optionally, an impression of the patient's old denture can be made with conventional laboratory putty and when hardened the bases can also be made at this stage by applying a meshed composite blank sheet over these hardened putty bases, pressing into place and trimming the peripheries with a sharp implement at the sulcule extensions. The bases are then hardened in a UV curer and the peripheral regions are trimmed to suit. The bases are described in further detail below in relation to FIGS. 45-51.

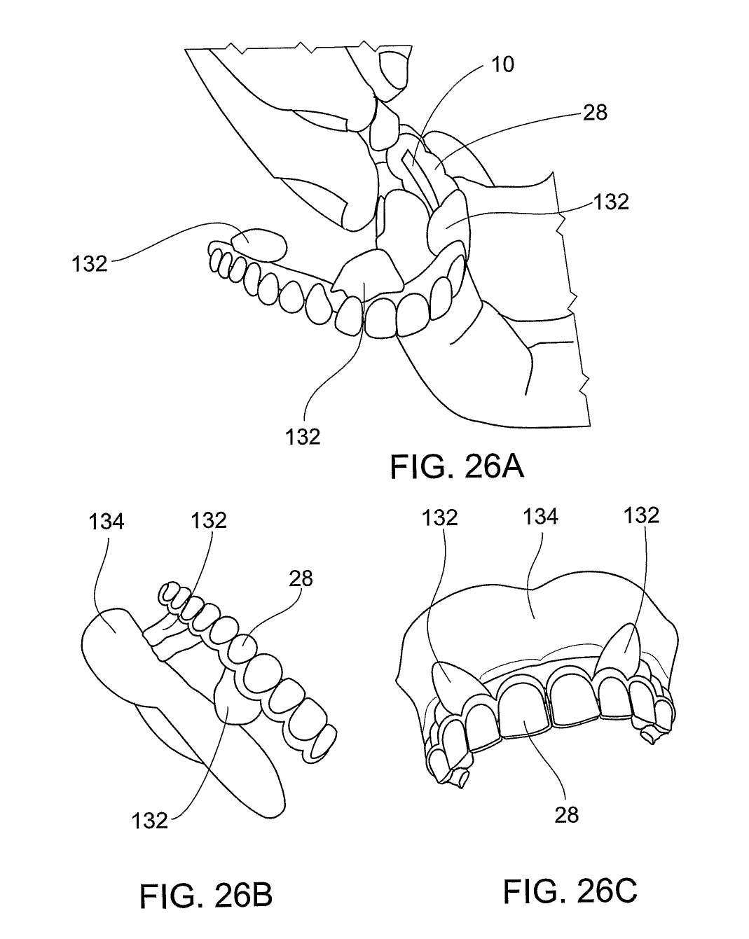

With reference to the upper bases 134 and the dental arches 28 shown in FIGS. 26B and 26C, with the upper and lower bases stabilized in the patient's mouth, for example with denture adhesive, such that the bases are temporarily attached to the patient's oral ridges 124, if required, the method then includes at 230 pressing small blobs or dabs 132 of light-curable composite material of an oversized dimensional height onto the upper base 134 in a plurality of positions, such as in the cuspid and first molar positions. Alternatively, the composite blobs or dabs 132 of light-curable composite material can be pressed onto the upper dental arch 28 comprising support 10 selected for the patient in similar positions, as shown in FIG. 26A. A composite bonding gel may be added to each contact end of the dabs 132, to affirm cohesion to the base and to the arch underbody. If a practioner prefers to locate the lower arch first, this system can also be successful by careful placement of the lower arch in the correct position first, curing it firm and then placing and fixing the upper arch to the lower arch. Dabs are then placed on the upper arch and base and the patient is asked to close their mouth until the required position is achieved.

Although the upper dental arch 28 is attached to the upper base via the dabs 132, the dabs have not yet been cured. Therefore, the method includes at 235 the dental practitioner positioning the dental arch 28 with respect to the upper base 134 to achieve the correct centric and occlusal positions and planes as well as the best aesthetic position for the patient. The denture practitioner is able to move and manipulate the dental arch 28 as required and can also check that there are no obstructions, especially at the retro or distal region.

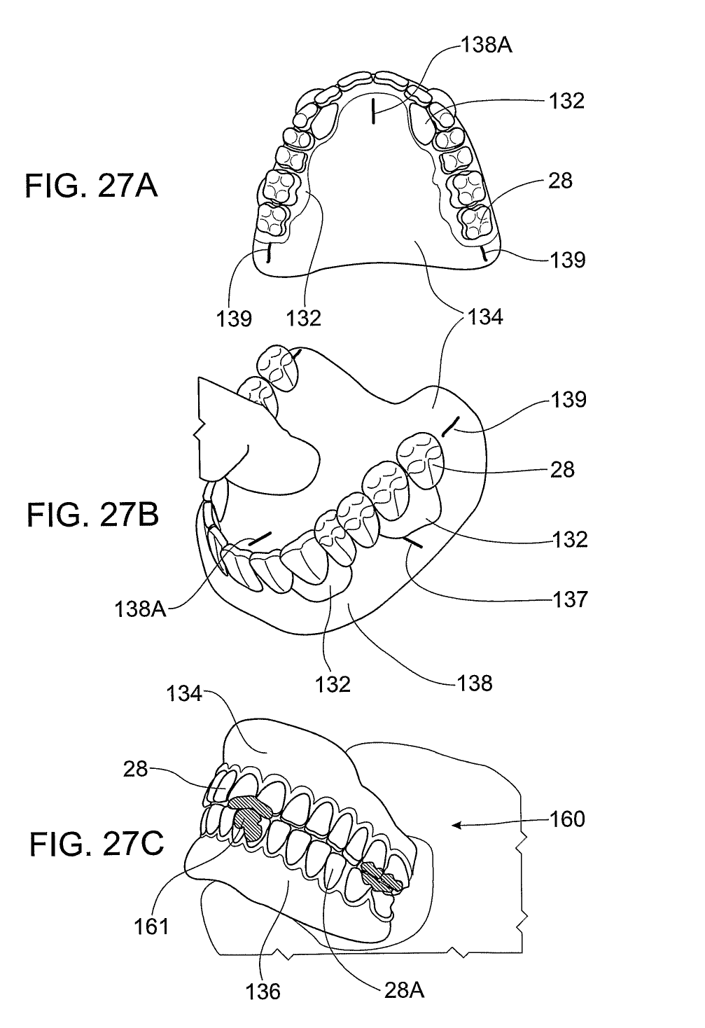

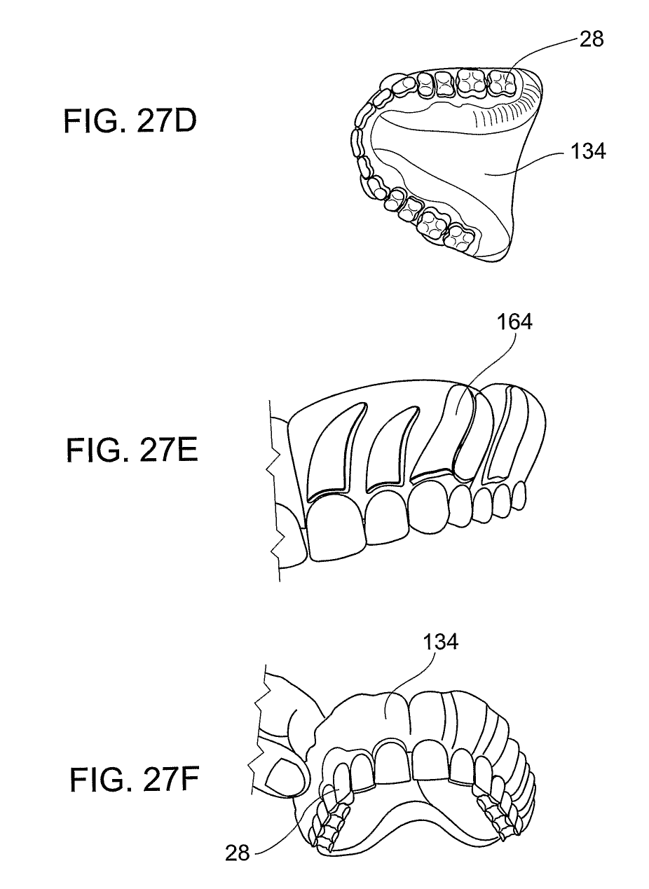

The method includes at 240 either light curing the dabs 132 with a general UV diffuser in the patient's mouth to cure all composite dabs together or curing each of the dabs 132 individually with a conventional hand held UV light such that the desired position of the dental arch 28 with respect to the base 134 is maintained. FIGS. 27A and 27B show the dental arch 28 secured to the upper base 134 with the light cured dabs 132. FIGS. 27A and 27B also show a mesio-buckle cusp marker 137, a cuspid marker 138, a centric marker 138A and a posterior fossa line 139 that can be used as guides for alignment of the dental arch 28 with the upper base 134.

At 245, the method includes checking the occlusal plane and the centric positions with a plane determining instrument, such as a fox plane or any other available conventional method used currently to determine the occlusal plane. For some reason, the positions may not be correct, for example, due to misplacement or other error, such as the dabs 132 not having been completely cured and/or not completely bonded, therefore causing uncertainty regarding the correct positions. The method then includes at 250 simply separating the dental arch 28 from the upper base 134 and repeating steps 235, 240 and 245 until the correct position of the dental arch 28 with respect to the upper base 134 has been achieved.

If the positions are correct, the method includes at 255 removing the upper base 134 and attached arch from the patient's mouth and interdigitating the associated lower dental arch with the upper dental arch, i.e. the lower arch is positioned correctly with respect to the upper dental arch such that the interdigitation and bite are correct. The lower arch is temporarily secured in the correct position to the upper arch with molten sticky wax.

At 260, the method includes placing the three unit appliance in the patient's mouth. The three unit appliance comprises the upper base 134 with the attached upper dental arch 28 and the lower dental arch interdigitated in perfect occlusion with, and attached to, the upper dental arch.

With the lower base also in the patient's mouth secured well to the oral ridge 124 with denture adhesive, the method includes at 265 trialling the registration position accurately until satisfied that the perfect centric and interrelation position of both the upper and lower jaws and therefore bases is achieved, making sure that the mandible and TMJ position is at the most re-truded rest position. Confirming a constant closing position is imperative for the patient to be assured a single, reoccurring position, without any premature contact or obstruction to the necessary jaw positions and vertical dimensions.

The method includes at 270 placing a number of composite dabs 132 between the lower dental arch and the lower base, for example, in the cuspid and first molar positions. The dabs can be placed on the lower dental arch or on the lower base. A composite bonding gel may be added to each contact end of the dabs 132 to affirm cohesion to the lower base and to the arch underbody.

At 273, the patient slowly closes their mouth so that the lower dental arch of the all-in-one, three unit appliance and the lower base is in the correct position and maintains the correct interdigitation, registration and occlusal plane. This includes checking the occlusal plane, centric position and OVD.

With reference to FIG. 27C, at 275, the method includes spot curing the lower composite dabs well before removing the four unit appliance 160 from the patient's mouth. The sequential formation of the four unit appliance 160 is the upper base 134 connected to the upper dental arch 28 via upper composite dabs, the upper dental arch 28 connected to the lower dental arch 28A via sticky wax 161 and the lower dental arch 28A connected to the lower base 136 via lower composite dabs. The upper base and upper arch with the attached lower base and lower arch are then separated from each other at the point of the interdigitating dental arches by separating the two arches secured together with sticky wax, after removing all remaining sticky wax at the interdigitating and occluding parts of the arches. The unfinished appliance is now ready to trial check the bite registration position and fit of the denture prior to finish. It must be noted that it doesn't matter that the sticky wax may break or dislodge whilst the process of removing the four unit appliance from the mouth is undertaken. The four unit appliance 160 can be removed as a two unit, separated upper and lower appliance because the two separate units, each unit comprising a base and an arch, is now stabilized and affixed by the hardened and cured composite dabs.

The method includes at 280 returning the upper and lower bases 134, 136 with their attached dental arches 28, 28A to the patient's mouth.

At 285, the method includes checking the fit, interdigitation and occlusal contacts, centric and appearance of the dentures by asking the patient to carefully open and close their jaw until contact of the occlusion of the two dental arches interdigitate, occlude and sit correctly. This includes checking the occlusal plane, centric position, OVD and RVD.

If there is any inconstant malocclusion or related problem, at 290, the method includes separating the lower dental arch 28A from the lower base 136 and repeating the method from step 255. If the positions are correct and both the denture practitioner and the patient are happy, the method includes at 295 removing the upper and lower denture from the patient's mouth and separating the upper and lower dental arches from each other. The denture adhesive used to secure the bases to the oral ridge and upper plate is removed and thoroughly cleaned from the under bases.

At 300, the method includes the dental practitioner deciding whether to complete the denture using either a composite method in accordance with embodiments of the present invention or using a conventional method. Method 200 continues in accordance with the composite method at 305 in FIG. 23A. Method 200 continues in accordance with the conventional method at 340 in FIG. 23B.

Referring to FIG. 23A, if the practitioner uses the composite method, the method includes at 305 placing a self cure composite gel in the upper and lower bases 134, 136, which are then placed back in the patient's mouth asking the patient to maintain position until the composite gel is partially cured to a solid consistency in its first setting/hardening stage, which usually takes about 2-3 minutes. The gel is allowed to flow outwards whilst still soft, thus filling the sulculus surrounding the peripheral extensions of the bases giving a natural roll on the peripheries completely around the bases and filling the bases with a more accurate lining of material for a more accurate and final fit.

The method includes at 310 removing the upper and lower dentures from the patient's mouth and placing them in a UV appliance to fully cure. The dentures are now ready for the finishing stage. Hence, the clinical consultation between the denture practitioner and the patient is complete in only one clinical visit.

The dentures at this point may either be sent to a denture laboratory for completion or be completed in-house at the clinic and placed in a UV curing appliance to be fully cured.

The method includes at 315 filling both dentures with composite material in both the lingual and labial areas, as shown in FIG. 27D. A length of flexible, acrylic composite material 100 in the form of a labial festooned apron as shown in FIG. 17 can be used to finish the denture with a festooned and naturally characterised appearance. The surfaces of the soft composites are smoothed out and the edges are feathered in well and integrated for smooth transition between hard and soft composite compounds. With reference to FIG. 27E, the festooning can also be hand made by cutting out a series of substantially triangular shaped wedges 164 from a composite sheet and placing them under each selected tooth neck to resemble the root structures. FIG. 27F shows a partially festooned denture with half of the upper base 134 yet to be festooned. The thickness created with the composite material around the peripheries can be varied to produce the desired effect. A brilliant lustre can be produced with a final finish layer placed on top, which means that the denture may not even need to be high shine polished mechanically resulting in further efficiencies.

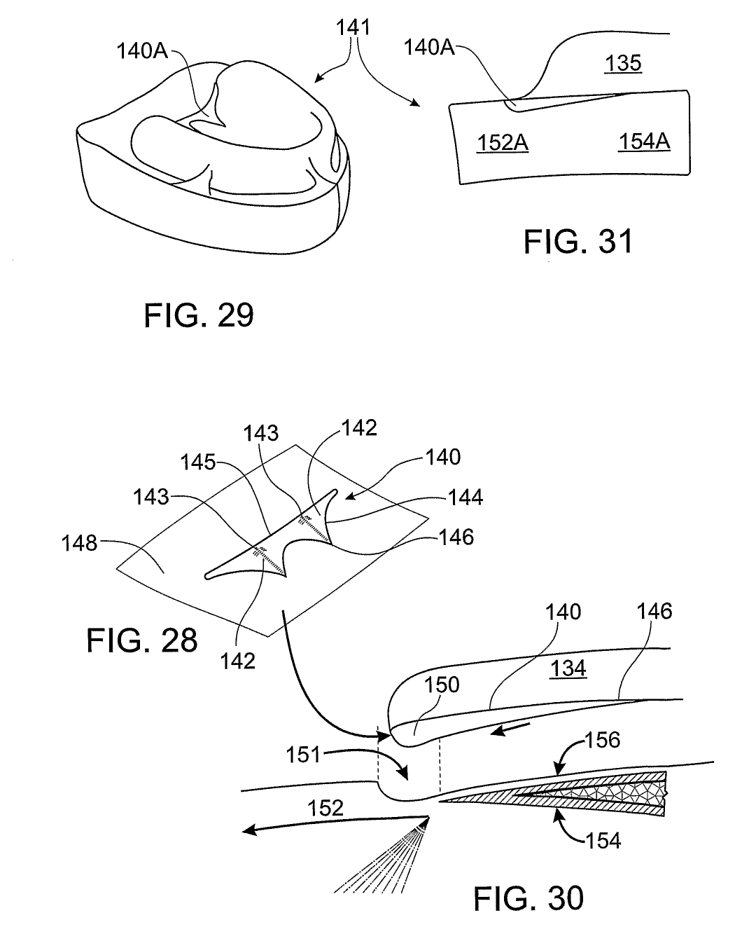

At 320, the method includes adding an indenting member 140 in the form of a post-dam indenter on the posterior region of the tissue contact side of the upper base to improve retention of the upper denture on the upper palate by virtue of an improved seal. An example of the post-dam indenter and its use is described below with reference to FIGS. 28-31.

Returning to the method, at 325, the method includes returning the two denture bases to the UV appliance for full curing. At 330, the dentures now go through the normal process of being trimmed, polished and sterilized after which they are ready for their second and final visit in the clinic.

At 335, the method 200 includes fitting the denture in the patient's mouth, checking for any tissue pain and trimming if necessary and the process is complete.

The method includes manufacturing the dentures from the upper and lower bases 134, 136 with the respective upper and lower dental arches 28, 28A secured in the correct positions in one of the conventional manners. The dentures can be made using the conventional known flasking, injection molding or composite manufacturing methods. Optionally, time can be saved when using the finishing method for the dentures by utilizing the UV composite adapt-and-fill method in the lingual section of the denture and the labial section by using the composite dental apron described above with reference to FIG. 17.

Referring to FIG. 23B, if the practitioner uses a conventional method, method 200 includes at 340 taking accurate impressions of the ridges more accurately with a rubber base impression material, as would normally be done in a denture relining process. This process includes placing the lower back in the patient's mouth and taking an impression of the upper asking the patient to close to the pre-recorded vertical dimension and making sure that interdigitation and tooth position and centric is perfect. The process is repeated for the lower base impression.

Once both bases have been recorded with the accurate impression material, the method 200 includes at 345 removing them from the mouth, rinsing and washing in sterilizing fluid and sending to the laboratory for waxing and processing for finish, as would be the process followed in a reline or rebuild method and process. The method includes at 350 forming the denture at the laboratory using a conventional method. Once the denture has been formed, they are then trimmed, polished, sterilized at 355 and returned to the clinic. The method 200 includes at 360 fitting the denture in the patient's mouth, checking for any tissue pain and trimming if necessary and the process is complete.

According to alternative embodiments of the method 200, the method includes following steps 205 to 225 as described above with reference to FIG. 22. Models can then be cast from the primary impressions of the patient's mouth using conventional materials either by the denture practitioner or in a laboratory. The upper and lower bases can then be molded from the cast models. If conventional wax registration rims are not used, steps 230 to 335 of the method 200 can then be followed as described above.

In other alternative embodiments of the method 200, if conventional wax registration rims are used, the method includes taking all the wax dimensions and markings and sending the attached upper and lower wax registration rims to the laboratory for articulation and for the setting of the dental arches 28. Hence, the dental arches can be supplied to either the denture practitioners and/or to the laboratories. The dental arches are set in perfect interdigitation quickly by placement of the upper arch in the appropriate markings of the registration rim in a single step and then placing the lower arch in a perfectly intergiditating relationship with the upper arch. Wax is assimilated all the way around the base rims to the composite acrylic 30 of the dental arches 28. The rims are festooned, optionally using a wax version of the apron as described above with reference to FIG. 17, and the rims are sent to the clinic for fitting with the patient. The method 200 can then be resumed from step 280 as shown in FIGS. 23-23B.

With reference to FIG. 28, according to embodiments of another aspect of the invention, an indenting member 140 in the form of a post-dam indenter is provided for attachment to an upper base 134. The indenting member 140 is designed to extend the width of the soft palate between the left and right tuberosity of the upper ridges at the vibrating line and is attached to the posterior region of the tissue contact side of the upper base 134 to improve retention of the upper denture on the upper palate. The indenting member 140 is a layer of composite material comprising two adjacent tapering regions 142 having sides 144 and points 146 extending from a base 145 of the indenting member 140. Each tapering region 142 has a raised profile 143 along a line extending from a respective point 146 to the base 145 and the raised profile decreases in height toward each side 144. The tapering regions 142 are designed to extend up to the transverse palatine suture of the palate and are provided in various sizes according to the patient's particular mouth size and shape. The indenting member 140 can be provided on a backing sheet 148 ready for application.

FIG. 29, which shows a stone model 141 of the upper oral ridge and upper palate, shows a depression 140A in the stone model 141 to create a conventional post dam indenter which would consequently be created with the flasking or injection process at the finishing stage, by filling the model 141 with acrylic. FIG. 29 shows the position and shape of the depression that will be made in the soft palate by the indenting member 140 at the vibrating line found between the soft and hard palate.

Referring to FIG. 30, the indenting member 140 is attached to the posterior region of the upper base 134 and reduces in thickness from a most posterior, rounded, thicker end 150 at the base 145 along tapering regions 142 to points 146. Hence, the indenting member 140 blends into the tissue contact side of the upper base 134. The rounded, thicker end 150 of the indenting member 140 creates an indent or depression 151 in the soft palate 152 of approximately 2-3 mm posterior of the hard palate 154 covered by the mucosa or soft tissue 156.

FIG. 31 shows a cross section of the stone model 141 and the carved out depression 140A in the model depicting the position, depth and contour of the post dam on the stone model 141. The model 141 shows the location of the depression 140A between the soft palate region 152A of the model 141, at the vibrating line, and the hard palate region 154A of the model 141. FIG. 31 also shows a depiction of the upper oral ridge 135. The indenting member 140 improves the seal between the upper base 134 of the denture and the soft palate 152 to help keep the upper base in place.

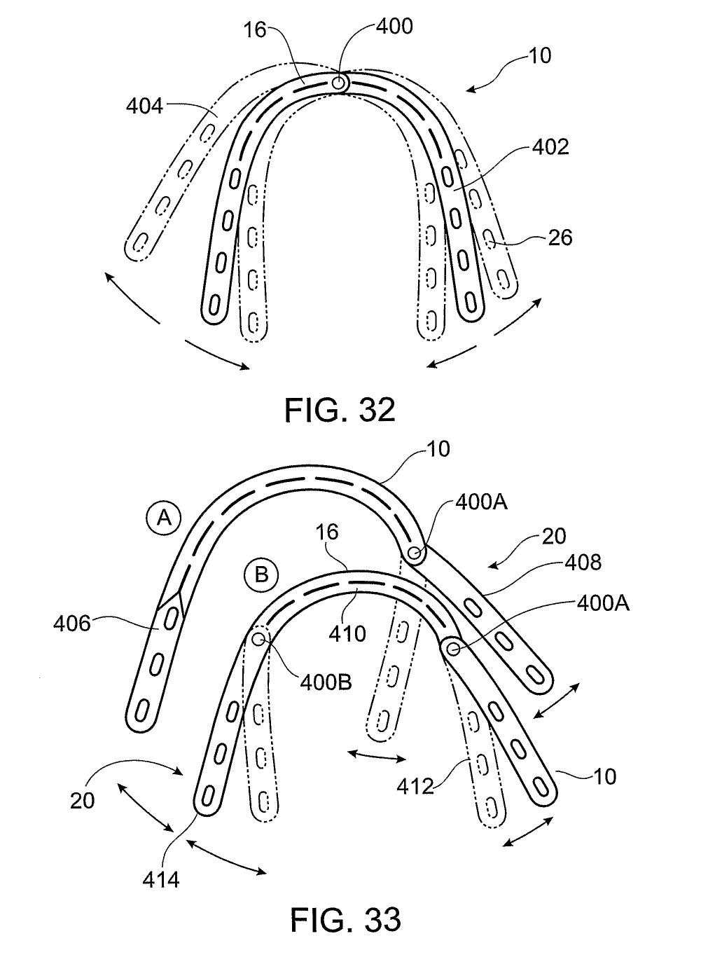

Yet further embodiments of the present invention relating to articulated supports and clip-on artificial teeth will now be described with reference to FIGS. 32-44.

Referring to FIG. 32, an embodiment of the support 10 comprises at least one joint 400 between at least two parts of the support in the form of a first elongate member 402 and a second elongate member 404. In this embodiment, the joint 400 is provided substantially centrally in the anterior region 16 of the support 10. The joint 400 allows the first and second elongate members 402, 404 to pivot relative to each other to enable the support to be adjusted to precisely the desired shape of the patient's dental arch. FIG. 32 shows three different positions for each of the first and second elongate members 402, 404, achieved by movement of the first and second elongate members 402, 404 indicated by the arrows. Hence, FIG. 32 shows nine different configurations for the support 10. However, it will be appreciated that there is a range of positions for the first and second elongate members 402, 404 and not merely the discrete positions shown in FIG. 32. Furthermore, whilst the support 10 is shown in FIG. 32 comprising apertures 26 for attaching artificial teeth, apertures 26 can be omitted and artificial teeth can be affixed to the support 10 by any of the other methods described herein.

Referring to FIG. 33, in other embodiments of the support 10, the at least one joint 400 is provided in at least one of the posterior regions 20 of the support. FIG. 33 shows two embodiments of the support 10—embodiment A in which the support 10 comprises a joint 400A in a right posterior region and embodiment B in which the support 10 comprises joints 400A, 400B in both right and left posterior regions. In embodiment A, support 10 comprises two parts in the form of an elongate and arcuate member 406 and an elongate member 408. This embodiment enables the angle of the support 10 in one of the posterior regions to be adjusted with respect to the remainder of the support 10. In embodiment B, support 10 comprises three parts in the form of an arcuate member 410 in an anterior region 16 and two elongate members 412, 414 in the posterior regions 20 joined to the arcuate member 410 at joints 400A, 400B respectively. This embodiment enables the angles of the support in both posterior regions 20 to be adjusted with respect to the anterior region 16 of the support 10.

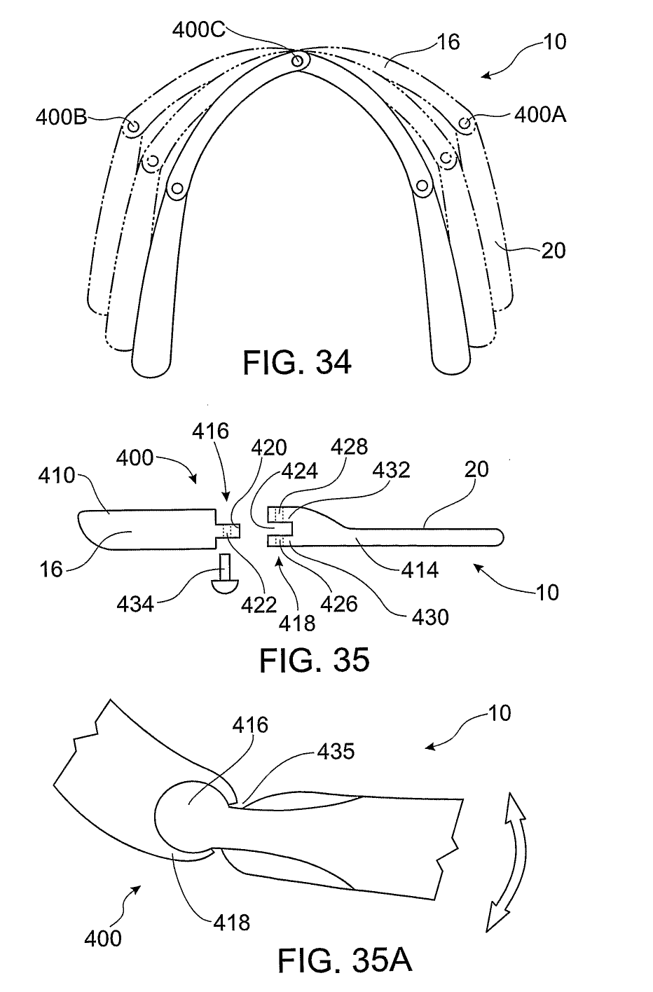

With reference to FIG. 34, embodiments of the support 10 can comprise four parts and three joints with the support 10 comprising a joint 400A in a right posterior region 20, a joint 400B in a left posterior region 20 and a joint 400C in the anterior region 16 of the support. Hence, the support 10 comprises two anterior parts and two posterior parts. FIG. 34 shows three of the many different configurations of the four-part support 10 comprising three joints, but it will be appreciated that many other configurations are achievable with this support other than the discrete configurations shown in FIG. 34.

The adaptability of the support 10 to patients' dental arches increases with the number of joints 400 in the support 10. However, even with a single joint 400, the support 10 is adaptable to a wide range of arches. The articulated dental supports are particularly useful for patients with asymmetric jaws, but the articulated supports can be used with symmetric or reasonably symmetric jaws.

The first and second elongate members 402, 404, the elongate and arcuate member 406, the elongate member 408, the arcuate member 410 and the two elongate members 412, 414 shown in FIGS. 32-34 can be provided in a range of sizes and shapes to provide even more adaptability. The members 402-414 can be provided in small, medium and large sizes or in one of the sizes 1-5 in the size scheme described herein. The members 402-414 can be shaped to suit square, tapered or ovoid shaped dental arches.

Referring to FIG. 35, according to some embodiments, the joint 400 between two parts of the support 10 is achieved with one part having a male profile 416 and the other part having a female profile 418. FIG. 35 shows a side view of a joint 400 between arcuate member 410 in an anterior region 16 and an elongate member 414 in the left posterior region 20. The male profile 416 comprises a projection 420 having an aperture 422 therethrough. Female profile 418 comprises a recess 424 and apertures 426, 428 in a base 430 and roof 432 respectively of the recess 424. Projection 420 is received within recess 424 and a pin 434 is passed through aligned apertures 422, 426 and 428 and secured in place by any suitable means, such as press-pinning, which allows arcuate member 410 and elongate member 414 to pivot with respect to each other.

FIG. 35A shows another variation of the joint 400, which also comprises one, first part of the support 10, such as a posterior part, having a projection or male profile 416 and the other, second part of the support 10, such as the anterior part, having a recess or female profile 418. In this embodiment, the male and female profiles 416, 418 are substantially circular. However, the pin 434 of the previous embodiment is omitted and the male profile 416 is held or engaged within the female profile 418 by the closeness of the fit between the two profiles. An opening 435 of the female profile 418 is narrower than the width of the male profile 416 and the male profile 416 cannot be removed through the opening 435. The male profile 416 is inserted into the female profile 418 from above or below and pivotal movement between the first part and the second part of about 7° either side of a central position is permitted.

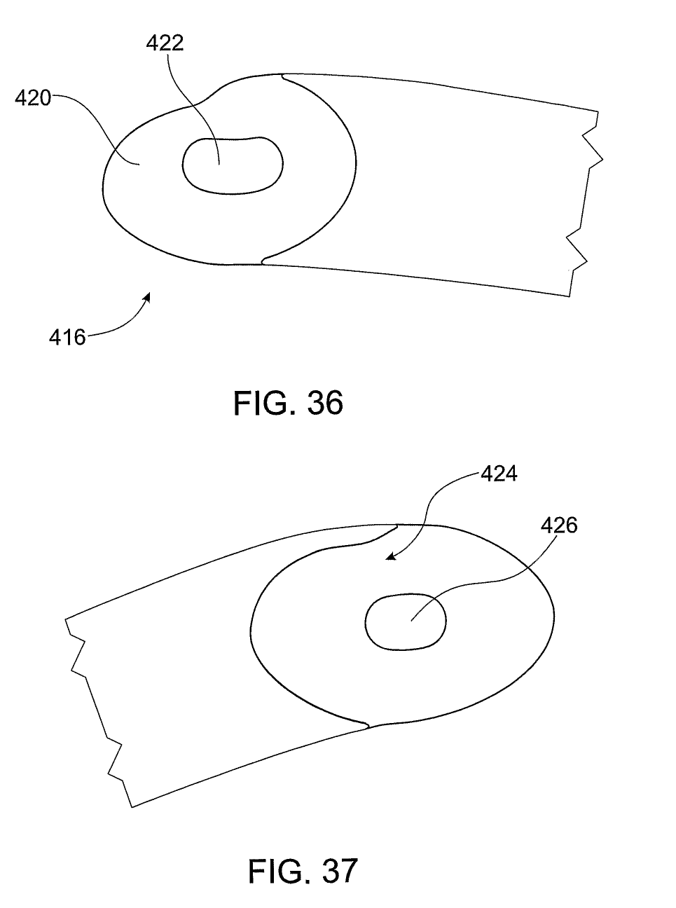

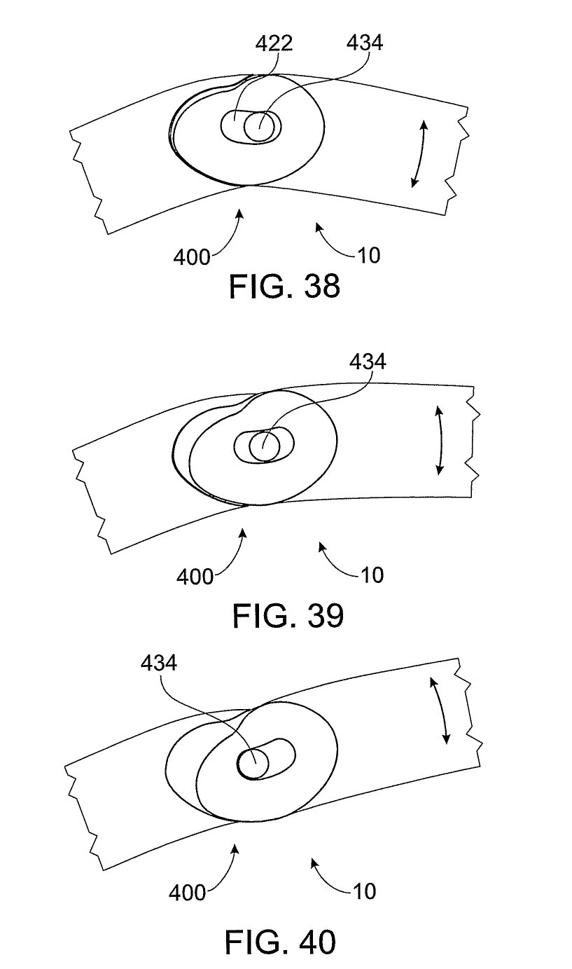

With reference to FIGS. 36-40, according to some embodiments, the projection 420 and the aperture 422 therethrough of the male profile 416 and the recess 424 of the female profile 418 have specific shapes to form a joint 400 that restricts the angle through which adjacent parts can pivot. FIG. 36 shows the projection 420 and the aperture 422 therethrough having a bean shape and FIG. 37 shows the recess 424 having a bean shape to receive the bean-shaped projection 420. Apertures 426 and 428 (not shown) of the female profile 418 are circular. With the pin 434 passing through apertures 422, 426 and 428, the movement shown in FIGS. 38-40 of one part of the support 10 relative to the other is achieved. The joint 400 thus comprises three-point contact and in some embodiments, movement of about 7° either side of a central position is permitted.

The joints described herein are machined to a high tolerance to provide an accurate fit between the parts of the support and to allow relative movement of adjacent parts of the support 10 in one plane only.

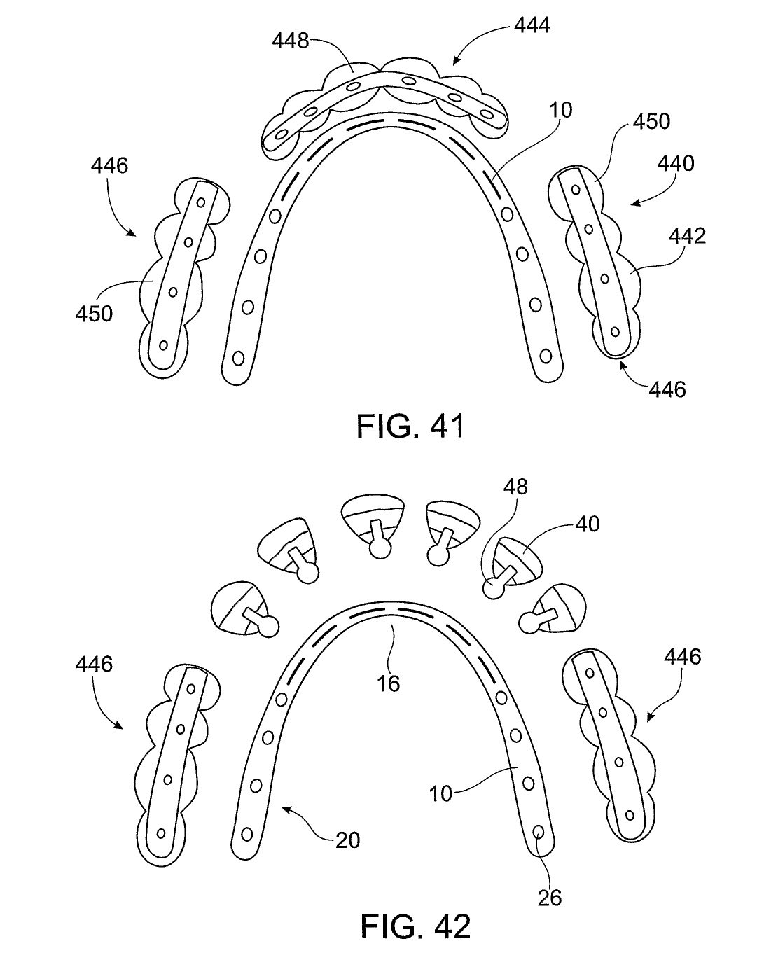

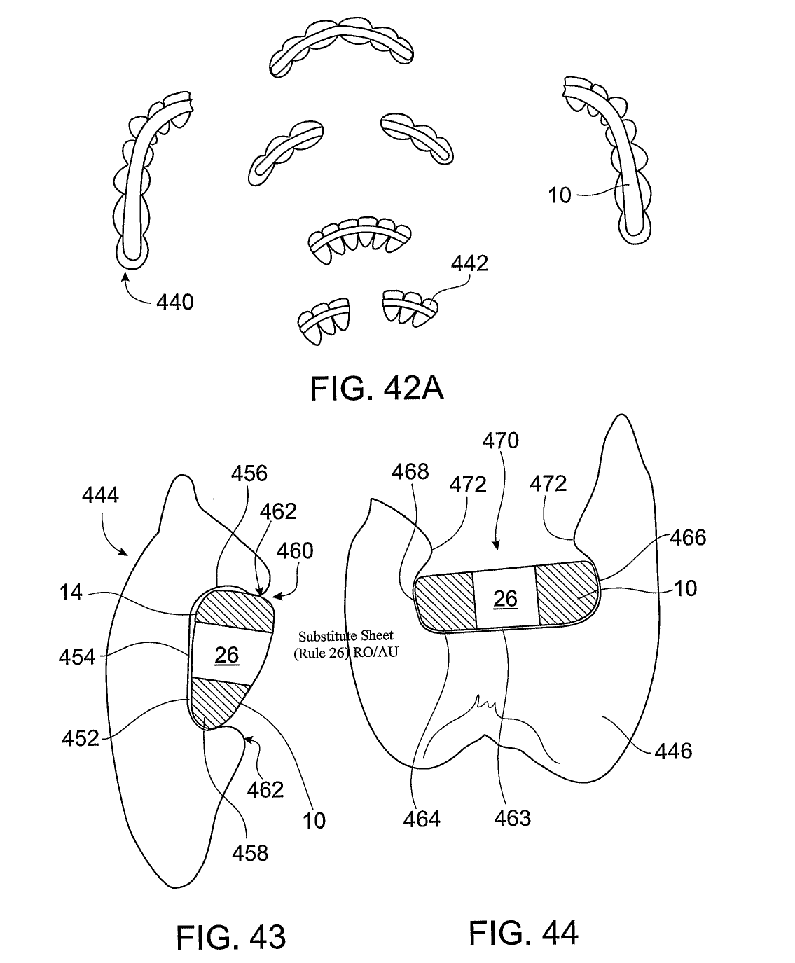

Referring now to FIGS. 41 and 42, according to some embodiments, the artificial teeth are in the form of clip-on artificial teeth, which clip on to the support 10. The clip-on artificial teeth can be in the form of a single clip-on artificial tooth or, as shown in FIG. 41, can be in the form of a clip-on unit 440 comprising multiple artificial teeth 442. The clip-on units 440 can be anterior clip-on units 444 or posterior clip-on units 446. In the example shown in FIG. 41, the anterior unit 444 comprises six anterior artificial teeth 448 and the two posterior units 446 each comprise four posterior artificial teeth 450. According to preferred embodiments, the clip-on units 440 comprise artificial teeth 442 and a region of artificial gum 443 made of any suitable material such as acrylic.

The clip-on artificial teeth can be used with any of the supports 10 according to embodiments of the present invention described herein. For example, with reference to FIG. 42, two posterior units 446 are used in the less visible posterior regions 20 with a support 10 comprising apertures 26 therein. In the anterior region 16, individual artificial teeth 40 are affixed to the support 10 via fasteners 48 passing through apertures 26 as described above. This allows an individual configuration of the more visible anterior teeth to be achieved. However, it will be appreciated that individual artificial teeth can be used in the posterior regions 20 if desired irrespective of whether a clip-on unit 440 or individual artificial teeth 40 are used in the anterior region 16.

According to some embodiments, the support comprises artificial teeth fixed to the support in the form of a dentition and one or more spaces for attaching artificial teeth. In the spaces individual clip-on artificial teeth or a clip-on unit comprising multiple artificial teeth can be attached. Alternatively, individual artificial teeth 40 can be affixed to the support 10 in the one or more spaces via fasteners 48 passing through apertures 26.

FIG. 42A shows further examples of the clip-on units 440 for clipping on to upper and lower supports 10 for both anterior and posterior regions. FIG. 42A shows clip-on units comprising three, six and seven artificial teeth 442, but it will be appreciated that the clip-on units can comprise any number of artificial teeth 442 from a single artificial tooth to a full set of artificial teeth. The clip-on units 440 are provided in a range of sizes and shapes to suit the size and shape of the patient's dental arch. Sizes can include small, medium and large or can be provided in accordance with a size scheme as described herein, such as sizes 1-5. Different shapes can include tapered, ovoid and square. The artificial teeth 442 are provided in a range of colours or shades to match a patient's remaining teeth or as required by the patient, as well as, a range of cusp shapes, heights and angles to accommodate the patients requirements.

Further details of the clip-on teeth will now be described with reference to FIGS. 43 and 44. FIG. 43 shows a sectional side view of an anterior clip-on unit 444 clipped on to the support 10. The support 10 is shown with an aperture 26 therethrough, although the aperture 26 is not used to attach the clip-on unit 444 to the support 10. The clip-on unit 444 comprises a channel 452 having a back wall 454 shaped to compliment the face 14 of the anterior region 16 of the support 10. The channel 452 comprises a curved upper surface 456 and a curved lower surface 458 to accommodate curved upper and lower surfaces of the support 10 and the channel 452 is of sufficient height to accommodate the height of the support 10. However, the height of an opening 460 of the channel 452 is smaller than the height of the support 10 such that the anterior clip on-unit 444 has a snap-fit with the support 10. Opening 460 comprises rounded ridges 462 to facilitate a smooth snap-fit of the support 10 into the channel 452 of the anterior clip-on unit 444.

FIG. 44 shows a sectional end view of a posterior clip-on unit 446 attached to the support 10. The posterior clip-on unit 446 comprises channel 463 having a base 464 shaped to compliment the underside of the posterior region 20 of the support 10. The channel 463 comprises curved side surfaces 466, 468 to accommodate curved side surfaces of the support 10 and the channel 452 is of sufficient width to accommodate the width of the support 10. However, the width of an opening 470 of the channel 463 is smaller than the width of the support 10 such that the posterior clip on-unit 446 has a snap-fit with the support 10. Opening 460 comprises rounded ridges 472 to facilitate a smooth snap-fit of the support 10 into the channel 463 of the posterior clip-on unit 446.

According to other embodiments, the clip-on units 440 can attach to the support 10 utilising the apertures 26 in the support. For example, as an alternative to, but preferably in addition to, the aforementioned channels 452, 463, the clip-on units can comprise a projection (not shown) for insertion through a respective aperture 26 in the support 10. The projection can comprise a resilient end to provide a snap-fit once inserted. The resilient end can be compressed to facilitate removal from the support if necessary.

With reference to FIG. 44A, according to other embodiments of the clip-on units 440, and in particular the posterior clip-on unit 446, a fastener 650 passing through one or more of the apertures 26 in the support 10 can be used to secure the clip-on units to the support. This can be in a similar manner to the embodiments of the artificial teeth described above with reference to FIGS. 9-10G. FIG. 44A shows a fastener 650, such as a threaded screw, passing through aperture 26 in the support 10 and into a threaded recess 652 in posterior clip-on unit 446. Support 10 can comprise an indentation 654 to accommodate at least part of a head of the fastener 650. It will be appreciated that the fastener 650 and threaded recess 652 may be used as an alternative to, or in addition to, the clip-on feature of the artificial teeth and as an alternative to, or in addition to using biocompatible adhesives for attaching the artificial teeth to the support 10.

In yet further embodiments of the artificial teeth according to some embodiments of the present invention, the artificial teeth can comprise an elongate recess or channel for receiving part of the support 10 such that the artificial teeth can be slid onto the support 10. For example, artificial teeth for a posterior region in the form of a unit, similar to the clip-on units shown in FIG. 44A, can comprise an elongate channel along opposite inner walls of the unit. The elongate channels can be sized and shaped to receive a portion of the support 10, such as substantially horizontal, planar regions of each posterior region 20 of the support 10. In this example, posterior units comprising artificial teeth slide onto posterior regions 20 of the support 10 corresponding to the first and second molar posterior regions. It is also envisaged that anterior units comprising artificial teeth could comprise an upper and lower elongate channel for slidably receiving the anterior portion 16 of the support 10.

Further embodiments of the present invention relating to bases, methods of production and methods of producing a denture will now be described with reference to FIGS. 45-51. At least some of the following methods are particularly useful in cases where a denture has been damaged, lost or it is the first time a patient has needed a denture.

FIG. 45 shows a base tray 500 for producing a lower denture comprising a handle 502 attached to the base tray 500. The handle 520 can be any suitable metal or plastics material, but stainless steel is an example of a preferred material. The handle 520 can be secured in a plurality of slots 504 in the base tray 500 as shown or by using one or more light-curable dabs of composite material as described herein. Base tray 500 comprises retention grooves 505 to aid adhesion of the support 10 and artificial teeth to the tray 500. FIG. 46 shows a base tray 506 for producing an upper denture with the handle 502 removed from the plurality of slots 504.

The base trays 500, 506 can be produced relatively quickly and easily by using standard dental laboratory putty and a catalyst mixed together and, for example, placing the mixture directly on the patient's existing upper and/or lower denture(s) or on a pre-existing model, if available. Alternatively, the base trays 500, 506 can be produced in a similar manner using a reinforced acrylic, such as PMMA, or another polymer, such as polypropylene, if conventional rubber base impressions will be produced.

As a further alternative, the base trays 500, 506 can be produced quickly and easily by placing the mesh reinforced flexible composite base material 90, as described herein according to embodiments of the present invention, directly on the patient's existing upper and/or lower denture(s). Where the denture(s) are not available, the mesh reinforced flexible composite base material 90 can be placed on the patient's oral ridge and gently pressed to the shape of the oral ridge. The shaped reinforced composite material is light cured and trimmed around the edges to quickly obtain upper and/or lower base trays 500, 506 tailor-made for the patient. The base trays 500, 506 can then be used to produce accurate dentures using the supports 10, artificial teeth, light-curable dabs of composite material, and methods of articulation in the patient's mouth as described herein.

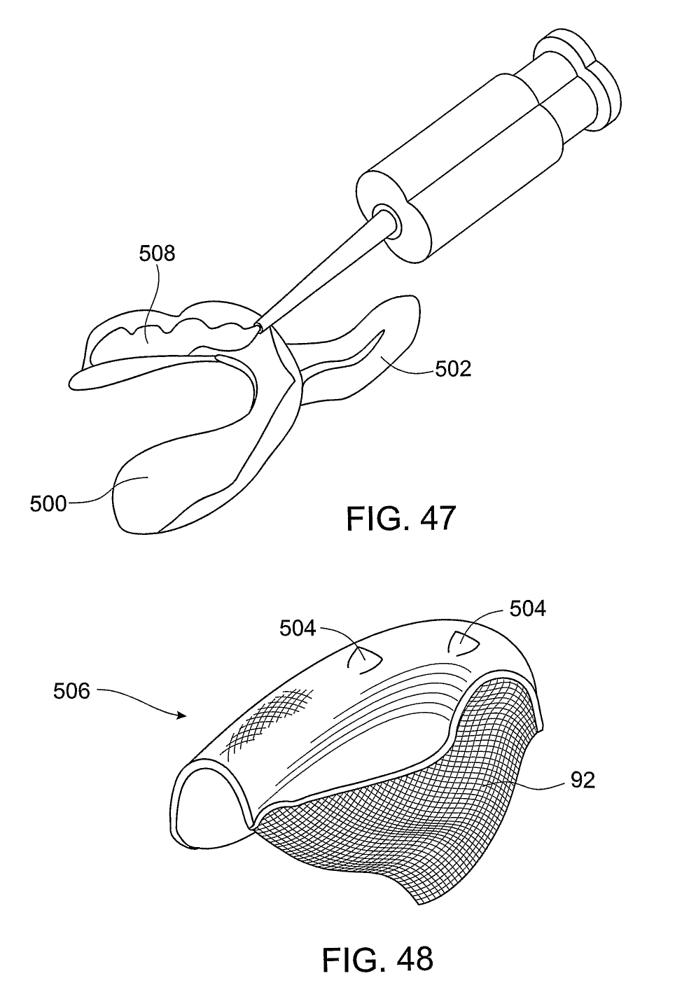

With reference to FIG. 47, alternatively, the base trays 500, 506 can be filled with a two-stage silicone based composite material 508, such as Ufi Gel available from VOCO America, Inc., or others, to take an impression of the patient's oral ridge. Alternatively, a rubber-based impression material can be used. The dentures can then be finished off in-house or outsourced to a dental technician or dental laboratory.

Referring to FIG. 48, another embodiment of the composite upper base tray 506 comprises the flexible biocompatible reinforcing mesh 92 therethrough as previously described herein. With reference to the exploded view in FIG. 48 and the rear view in FIG. 50, at least one portion of the flexible biocompatible reinforcing mesh 92 of the tray 506 is exposed. In the embodiments shown, the tray 506 initially comprises a flexible reinforcing mesh vault 510 without the composite material. The size and shape of the vault varies between patients and the inventor has identified that the flexible reinforcing mesh vault 510 allows a particularly accurate fit of the upper tray 506, and therefore the upper denture, to the patient. Separate upper and lower sheets 512, 514 of soft, flexible, uncured composite material are affixed to the upper tray 506 above and below the flexible mesh vault 510 respectively and bonded thereto using any suitable bonding process, such as a liquid bonding agent. The vault of the denture can then be accurately moulded to the patient's unique vault regardless of any osseo-palatal abnormalities and then light cured. An unnecessarily thick vault is avoided and therefore a comfortable fit is achieved and material is not wasted.

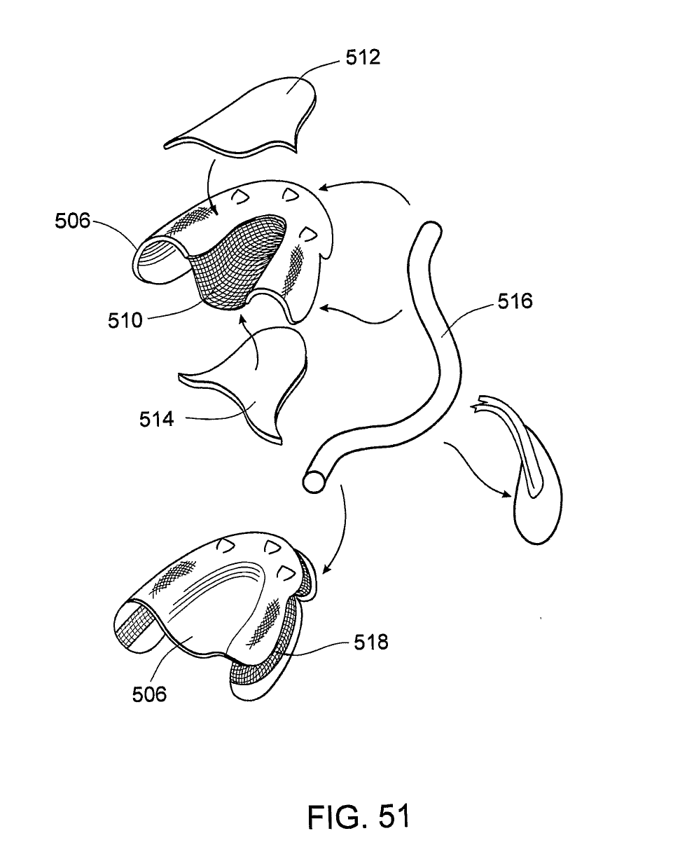

With reference to FIG. 51, a rod 516 of composite material can be affixed to the periphery of the upper base tray 506 by any suitable means moulded to the patient's mouth to achieve a perfect fit with the extremities of the patient's mouth.

According to some embodiments, the composite material can also be initially omitted from the periphery of the upper base tray 506 as well as, or alternatively to, the vault 510. In such embodiments, the upper base tray 506 comprises a flexible reinforcing mesh skirt 518. The rod 516 of composite material can then be affixed to the periphery of the upper base tray 506 around the skirt 518 to achieve an accurate fit to the extremities of the patient's mouth.

The lower base tray 500 can also comprise a flexible reinforcing mesh skirt in the labial and/or lingual regions of the tray 500 to achieve an accurate fit to the patient's mouth. Variations in the thickness of patients' oral ridges can be accommodated by achieving just the correct thickness and shape of composite material around the periphery to maximize accuracy of fit and therefore comfort of the denture.

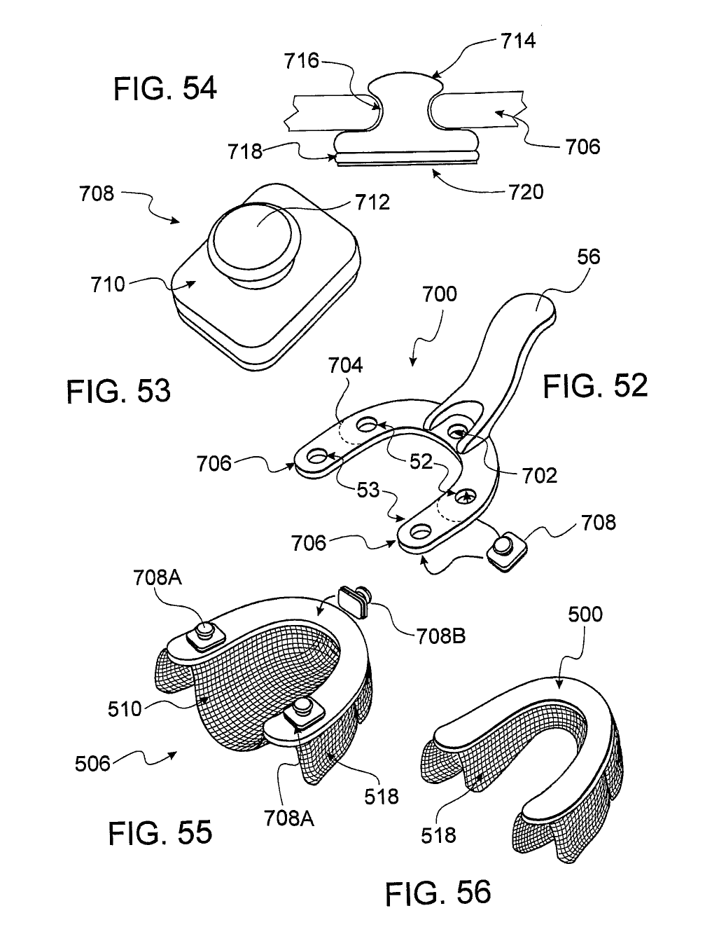

Further variations and embodiments of the present invention are shown in FIGS. 52-56. FIG. 52 is a perspective view of an arcuate member 700 for use with upper and lower base trays as described herein, such as lower and upper base trays 500, 506. Arcuate member 700 can be in the form of arcuate member 50 as described above, for example, in relation to FIGS. 12-14. Arcuate member 700 comprises a handle 56 extending above the plane of the arcuate member 700 and a plurality of apertures in the form of a pair of anterior apertures 52 in the left and right anterior region closer to the handle 56 and at least one pair of posterior apertures 53 in the left and right posterior region. Arcuate member 700 comprises central aperture 702 and a trimming line 704 on each arm 706 between anterior apertures 52 and posterior apertures 53 along which arms 706 can be cut to reduce the size of the arcuate member 700 to suit the size of the patient's mouth. Arcuate member 700 can be provided in a range of sizes, such as five different sizes, according to a sizing scheme as described above. FIG. 52 also shows a connector 708 which is removably insertable into the apertures 52, 53 for connecting the arcuate member 700 to base trays as described below.

FIG. 53 shows an enlarged perspective view of the connector 708, which can be clipped on to the arcuate member 700. Connector 708 comprises a body 710 having a protrusion 712 extending therefrom. Protrusion 712 comprises an enlarged end 714 and a waist 716 between the end 714 and body 710 of the connector 708. Protrusion 712 can be formed of resilient material allowing it to be inserted at least partially through one of the apertures 52, 53 in arcuate member 700, as shown in the cross sectional view in FIG. 54. A perimeter of one of the apertures 52, 53 formed by one of the arms 706 engages with the waist 716 to hold the connector 708 in place in the aperture. Some embodiments of the connector 708 comprise an adhesive 712 applied to an underside of the body 710 for attaching the connectors 708 to upper or lower base trays, as shown in FIG. 55. The adhesive 712 can be covered by a removable cover 714 to maintain its adhesive characteristic until it is ready to be used. Alternatively, connectors can be attached to upper or lower base trays with conventional biocompatible adhesive.

FIG. 55 shows an upper base tray 506 comprising a pair of connectors 708A attached to posterior regions of the base tray 506 and a connector 708B about to be attached to an anterior region. Arcuate member 700 can then be attached to the connectors 708A, 708B via posterior apertures 53 and central aperture 702 respectively. Alternatively, connectors 708A, 708B can first be engaged by apertures 53, 702 of the arcuate member 700 and then adhered to base tray 506. The upper base tray 506 illustrated in FIG. 55 also comprises flexible reinforcing mesh vault 510 and flexible reinforcing mesh skirt 518 as described above. FIG. 56 shows a lower base tray 500 comprising a flexible reinforcing mesh skirt 518 ready for attachment of the arcuate member 700 using connectors 708.

Hence, the supports 10, dental arches 28, dentures, arcuate members 50, inserts 110, 125, and post dam indenter 140, systems, methods and other apparatus disclosed herein address at least some of the aforementioned problems of the prior art by vastly reducing the time taken to produce a denture for a patient and significantly assuring tooth arrangement and improving the quality and strength of the denture. The denture can be accurately fitted typically in only two visits to the denture practitioner and the process is much more accurate because the patient's actual physiological articulation is being used directly to construct the denture, rather than using a conventional mechanical articulating device. The dental arches 28 comprising the support 10 and the reinforced flexible composite base plate material 90 provide additional strength and durability to the denture. The method of accurately fitting the dental arches to the upper and lower bases is vastly simplified compared with the prior art. The accurate fitting of the dental arches to the bases is conducted purely and solely by the denture practitioner with the patient's actual natural jaw directly in one session. The patient is the articulator for the dentures rather than using a pseudo-positioning mechanical device, such as conventional articulators in their basic or most intricate form, which achieve much less accurate results. Any errors in the clinical process are thus quickly identified and easily rectified in the same session without any laboratory interaction or interference.

The high frequency of transporting impressions, registration rims, fully setup try-ins and the like between the clinic and the laboratory encountered with the prior art systems and methods is vastly reduced, and even totally eliminated in some cases. This reduces and/or removes the number of interactions between the denture practitioner, laboratory technician and transporters, which also reduces the opportunities for errors to be made due to mishaps and/or miscommunication between the denture practitioner and the laboratory technician and/or due to damage in transit. Patients will be able to receive their completely finished comfortable dentures in a much shorter timeframe thus minimizing the inconvenience of being without their dentures. Vastly reduced errors in the process enable the denture practitioners and laboratory technicians to attend to the needs of more patients and increase profits. In addition, the dentures made in accordance with the present invention are also vastly stronger due to the metal support 10 surrounding the base of the dentition and strengthening mesh 92 covering the total fitting base and surrounding flanges of both upper and lower. Dentures according to embodiments of the present invention also demonstrate superior performance by virtue of features such as the indenting member 140.

There is a dramatic improvement in the aesthetics of the dentures produced in accordance with embodiments of the present invention by virtue of the ability to position individual artificial teeth in the desired position and orientation, which produces a much more natural looking denture and accommodates the patient's bite. Festooning around the flanges of the dentures with the apron also produces a more natural looking denture and its simplicity of application reduces production times whilst maintaining quality.

The articulated supports provide yet further adaptability of the supports to the wide range of sizes and shapes of patients' dental arches to maintain accurate and natural looking dentures even with abnormally sized and shaped arches and bites.

The clip-on units comprising one or more artificial teeth further enhance the systems and methods described herein by providing a simple yet robust attachment mechanism that further speeds up the denture production process. The clip-on units can also be used with other forms of artificial teeth described herein, such as the individual teeth fastened to the support via apertures therein.

The upper and lower base trays described herein are particularly useful in cases where a denture has been damaged, lost or it is the first time a patient has needed a denture. The upper and lower base trays further simplify and speed up the dentures production process and the base trays with the flexible reinforced mesh vault and/or skirt further improve the accuracy of fit of the denture.

The systems, methods and apparatus according to the various embodiments and aspects of the present invention can be used by denture professionals, laboratory technicians and associates in conjunction with conventional systems or methods currently in use and can be introduced at any stage of the conventional process currently used.

Throughout the specification the aim has been to describe the invention without limiting the invention to any one embodiment or specific collection of features. Persons skilled in the relevant art may realize variations from the specific embodiments that will nonetheless fall within the scope of the invention. For example, some of the steps of the methods do not necessarily need to be performed in the order described and can be performed in a different order. For example, in method 200, determining the sizes and shapes of the dental arch and artificial teeth can be performed before or after taking an impression of the dental arch.

1. A rigid support of a dental arch of a denture, the support comprising a rigid elongate member curved to substantially follow a curve of a dental arch wherein an anterior region of the elongate member morphs into posterior regions of the elongate member approximately at post cuspid regions, flattening towards a more horizontal formation from second bi-cuspid regions to molar regions.

2. The support of claim 1, wherein the elongate member is made of one of the following materials: a metallic material; titanium; stainless steel; high carbon steel; a metal alloy; ceramics; carbon fibre; at least one polymer; a fibre composite.

3. The support of claim 1, wherein a face of a front or anterior region of the elongate member is substantially perpendicular to faces of rear or posterior regions of the elongate member and/or the face of the anterior region is substantially parallel to one or more front surfaces of artificial incisor teeth of the dental arch.

4. The support of claim 1, wherein the elongate member comprises a transitional region between the anterior region and each posterior region, the transitional region optionally comprising a twist or flattening between the anterior region and each posterior region.

5. (canceled)

6. The support of claim 1, wherein a face of the elongate member is substantially parallel to surfaces of artificial teeth of the dental arch.

7. (canceled)

8. The support of claim 1, wherein faces of posterior regions of the elongate member are substantially parallel to one or more of the following: one or more biting occlusal surfaces of artificial molar teeth; artificial bicuspid teeth of the dental arch.

9. The support of claim 1, wherein the support is provided in one or more of the following: a range of dental arch shapes; a range of dental arch sizes.

10. The support of claim 1, wherein the elongate member comprises substantially horizontal, planar regions approximately under first and second molar posterior regions and/or wherein each posterior region includes a textured surface and/or wherein the elongate member comprising one or more apertures through the elongate member.

11. (canceled)

12. (canceled)

13. The support of claim 1, comprising at least one joint between at least two parts of the support.

14. The support of claim 13, wherein the at least one joint is provided substantially centrally in an anterior region of the support and/or in at least one posterior region of the support.

15. (canceled)

16. The support of claim 13, comprising a joint in a left hand posterior region, a joint in a right hand posterior region and a joint in an anterior region of the support.

17. The support of claim 1, comprising at least one artificial tooth attached to the support.

18. The support of claim 17, wherein the at least one artificial tooth clips on to the support, optionally wherein the at least one artificial tooth is part of a clip-on unit comprising a region of artificial gum, the clip-on unit being an anterior unit or a posterior unit.

19. (canceled)

20. (canceled)

21. The support of claim 1, comprising one or more artificial teeth fixed to the support and one or more spaces for attaching a clip-on artificial tooth or a clip-on unit comprising at least one artificial tooth and a region of artificial gum.

22. The support of claim 17, wherein the at least one artificial tooth is permanently affixed or adjustably affixed to the elongate member.

23. (canceled)

24. The support of claim 22, wherein the at least one artificial tooth is adjustably affixed to the elongate member via a fastener passing through an aperture in the elongate member for attachment to a respective back of the artificial tooth.

25. The support of claim 24, wherein the respective back of the artificial tooth comprises a recess for engaging an end of the fastener or comprises a male projection for engagement by a female socket in an end of the fastener.

26. (canceled)

27. The support of claim 24, wherein one or more of the following of the at least one artificial tooth is adjustable: a vertical position with respect to the aperture; a lateral position with respect to the aperture; an angle of incisal inclination with respect to the elongate member.

28. (canceled)

29. The support of claim 13, wherein the joint comprises:
a first part having a projection comprising a bean-shaped aperture therethrough;
a second part comprising a bean shaped recess to receive the bean-shaped projection; and
a pin passing through the bean shaped aperture in the projection and through an aperture in the recess about which the first part can pivot relative to the second part in a single plane.

30. The support of claim 29, comprising three contact points between the bean-shaped aperture and the bean-shaped projection.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. An indenting member for permanent attachment to a posterior region of a tissue contact side of an upper base of an upper denture to improve retention of the upper denture on the upper palate.

63. The indenting member of claim 62, wherein the indenting member extends a width of the soft palate between left and right tuberosity of upper ridges at the vibrating line.

64. The indenting member of claim 62, wherein the indenting member comprises two adjacent tapering regions extending and tapering from a base of the indenting member to compressive soft tissue over the transverse palatine suture of the palate.

65. A method of producing a denture including:
temporarily affixing a base to an oral ridge of a patient;
temporarily affixing a dental arch comprising artificial teeth onto the base with light-curable composite material;
adjusting the position of the dental arch with respect to the base and the patients' dental dimensions in the patient's mouth until a desired position is achieved; and
light-curing the composite material in the patient's mouth.

66. The method of claim 65, including interdigitating occlusal surfaces of an opposing lower dental arch to a related upper dental arch after the desired position and appropriate dimensions of the upper dental arch with respect to an upper base and the patients' dental dimensions are achieved.

67. The method of claim 65, including achieving the desired position and appropriate dimensions of the lower dental arch with respect to a lower base and then interdigitating occlusal surfaces of an opposing upper dental arch to the related lower dental arch.
